(19) United States
(12) Patent Application Publication
(10) Pub. No.: US 2012/0086734 A1
(43) Pub. Date: Apr. 12, 2012

(54) IMAGE DISPLAY APPARATUS

(75) Inventors: Kensuke Kitani, Kawasaki-shi (JP); Ayumu Wada, Kawasaki-shi (JP)

(73) Assignee: CANON KABUSHIKI KAISHA, Tokyo (JP)

(21) Appl. No.: 13/267,752

(22) Filed: Oct. 6, 2011

(30) Foreign Application Priority Data
Oct. 12, 2010 (JP) 2010-229818

(51) Int. Cl. G09G 5/10

(52) U.S. Cl. 345/690

(57) ABSTRACT

In an extension area of a transmission member composed of (4m+a) signal lines, a medium value D_{Me1} of the center-to-center distance Dₖ between each signal line belonging to a first partial group composed of m signal lines and a neighboring signal line thereof and a medium value D_{Me2} of the center-to-center distance Dₖ between each signal line belonging to a second partial group composed of m signal lines and a neighboring signal line thereof are smaller than a medium value D_{Me3} of the center-to-center distance Dₖ between mutually neighboring signal lines belonging to a third partial group composed of (2m+a) signal lines.

### BACKGROUND OF THE INVENTION

1. Field of the Invention

Embodiments of the present invention relate to an image display apparatus. More specifically, embodiments of the present invention relate to a transmission member included in the image display apparatus.

2. Description of the Related Art

An image display apparatus is generally required to have a display screen that is large in scale, high in definition, and excellent in image quality. Therefore, if a transmission member including a plurality of signal lines is provided to transmit electric signals, the transmission member tends to behave as a distributed constant circuit. As a result, the electric signal contains noises inherent to the distributed constant circuit and adversely influences the display quality (i.e., image quality) of the image display apparatus.

As discussed in Japanese Patent Application Laid-Open No. 2007-219496, it is conventionally known that the dispersion in the influence of inductance component of respective signal lines (signal wiring) provided on a wiring material (i.e., a transmission member) causes unevenness in luminance (unevenness in display).

### SUMMARY OF THE INVENTION

Exemplary embodiments of the present invention are directed to a technique capable of reducing the unevenness in display, which may appear when an image display apparatus includes a transmission member.

According to an aspect of the present invention, an image display apparatus includes a display panel that includes a plurality of display elements and a plurality of terminals electrically connected to the plurality of display elements, respectively, an integrated circuit configured to output an electric signal to drive each of the plurality of display elements, and a plurality of transmission members disposed in a mutually spaced relationship and configured to transmit electric signals from the integrated circuit to the plurality of terminals. Each of the plurality of transmission members includes a signal line group composed of (4m+a) signal lines, which connect the plurality of terminals to the integrated circuit and transmit the electric signal, and an insulating substrate that supports the signal line group, wherein each of the plurality of transmission members includes an area in which the (4m+a) signal lines that constitute the signal line group are extended in the same direction and aligned in a mutually spaced relationship. In the area, the signal line group includes a first partial group composed of m signal lines, a second partial group composed of m signal lines, and a third partial group composed of (2m+a) signal lines and positioned between the first partial group and the second partial group. A center-to-center distance between mutually neighboring signal lines of the first partial group and a center-to-center distance between mutually neighboring signal lines of the second partial group are set to be shorter than a center-to-center distance between mutually neighboring signal lines of the third partial group, so that, when the integrated circuit outputs the electric signal to the (4m+a) signal lines that constitute the signal line group to drive the plurality of display elements at a same luminance level, the luminance of the plurality of display elements connected to the signal lines that constitute the first partial group and the second partial group becomes equal to the luminance of the plurality of display elements connected to the signal lines that constitute the third partial group (in which “m” is an arbitrary natural number equal to or greater than 2, and “a” is any one of 0, 1, 2, and 3).

Exemplary embodiments of the present invention may reduce the unevenness in display that may appear on an image display apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B schematically illustrate an example of an image display apparatus according to an exemplary embodiment of the present invention.

FIGS. 2A and 2B schematically illustrate an example of an image display apparatus according to an exemplary embodiment of the present invention.

FIGS. 3A and 3B schematically illustrate an example of an image display apparatus according to an exemplary embodiment of the present invention.

FIGS. 4A to 4C schematically illustrate a wiring configuration according to a first exemplary embodiment of the present invention.

FIGS. 5A to 5C schematically illustrate a wiring configuration according to a second exemplary embodiment of the present invention.

FIGS. 6A to 6C schematically illustrate a wiring configuration according to a third exemplary embodiment of the present invention.

FIGS. 7A and 7B schematically illustrate a wiring configuration according to a fourth exemplary embodiment of the present invention.

FIGS. 8A to 8C schematically illustrate a wiring configuration according to a fifth exemplary embodiment of the present invention.

FIGS. 9A and 9B schematically illustrate a wiring configuration according to a sixth exemplary embodiment of the present invention.

FIGS. 10A and 10B schematically illustrate characteristics that maybe obtained by an exemplary embodiment of the present invention.

FIGS. 11A and 11B schematically illustrate improvement in display that may be obtained by an exemplary embodiment of the present invention.

### DESCRIPTION OF THE EMBODIMENTS

Various exemplary embodiments, features, and aspects of the invention will be described in detail below with reference to the drawings.

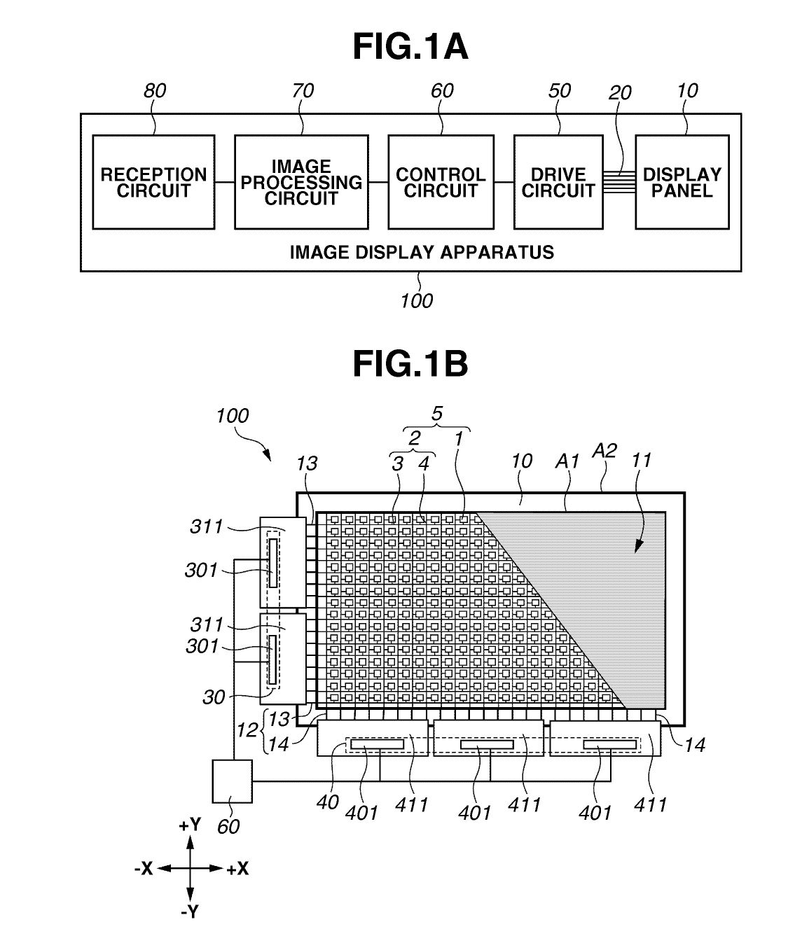

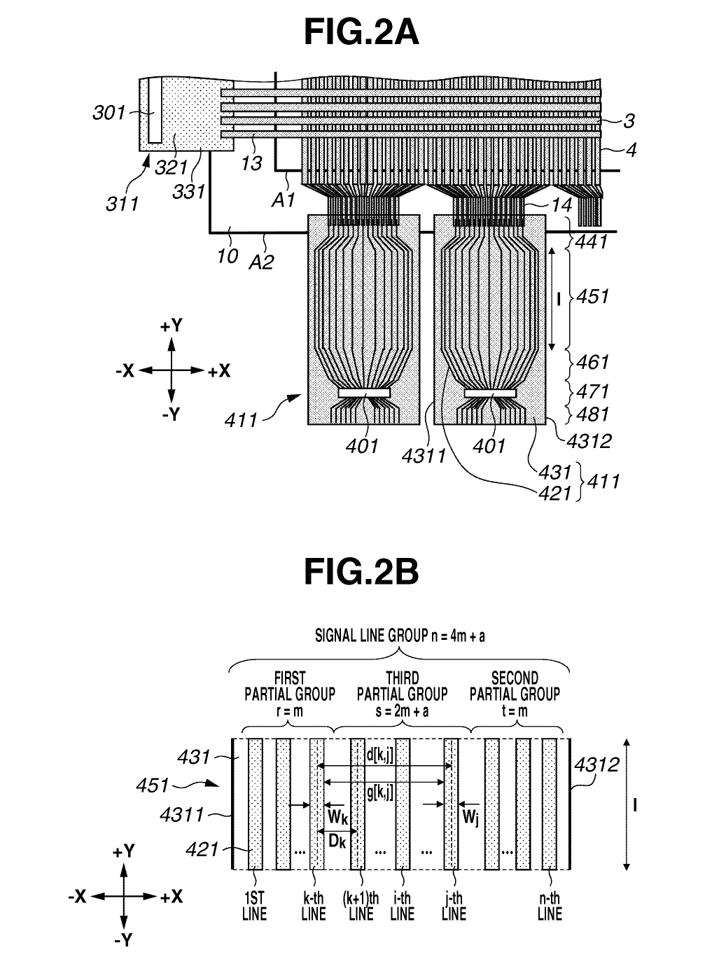

First, an example of an image display apparatus is described in detail below with reference to FIGS. 1A and 1B and FIGS. 2A and 2B.

FIG. 1A is a block diagram illustrating a main portion of an image display apparatus 100. FIG. 1B schematically illustrates an example configuration of a part of the main portion of the image display apparatus 100. The image display apparatus 100 includes a display panel 10. The display panel 10 has a display screen 11 on which an image may be displayed. The image display apparatus 100 further includes a drive circuit 50 that may generate a drive signal to display an image on the display screen 11 of the display panel 10. Further, the image display apparatus 100 includes a transmitting medium 20 that may transmit the drive signal, when generated by the drive circuit 50, to the display panel 10.

Although described in detail below, as illustrated in FIGS. 2A and 2B, the transmitting medium 20 includes a plurality of transmission members (311, 411). Each transmission member may be constituted by a plurality of signal line groups each being composed of eight or more signal lines (321, 421).

In the present exemplary embodiment, the center-to-center distance between mutually neighboring signal lines of each signal line group is not constant. Further, the center-to-center distance between mutually neighboring signal lines of each signal line group satisfies predetermined conditions (which are described below) with respect to the distribution thereof in such a way as to reduce the display unevenness that may appear due to the presence of the transmitting medium 20.

The display panel 10 includes a display unit 5 positioned in an internal area (i.e., an area surrounded by a bold line Al) illustrated in FIG. 1B. The internal area is an orthogonal projection area of the display screen 11. FIG. 1B illustrates the display unit 5 as a see-through part of the display screen 11.

Typically, the internal area of the display panel 10 is an intervening area between a pair of substrates that fixes the display unit 5. The display unit 5 includes a plurality of display elements 1 and an internal wiring 2. The internal wiring 2 is provided in the internal area to electrically connect the plurality of display elements 1 to the drive circuit 50.

The internal wiring 2 may be constituted by a matrix wiring when numerous display elements 1 are disposed in a matrix pattern. In this case, the matrix wiring is composed of plural (numerous) scanning lines 3 and plural (numerous) modulation lines 4, which are disposed to be intersectional with each other.

In FIG. 1B, a bold line A2 indicates an outer periphery of the display panel 10. The bold line A1 and the bold line A2 define an external area, in which plural (numerous) external terminals 12 (i.e., scanning wiring terminals 13 and modulation wiring terminals 14) are provided. The external terminals 12 are electrically connected to the scanning lines 3 and the modulation lines 4 that constitute the internal wiring 2. As a result, the plural (numerous) external terminals 12 are electrically connected to the plural (numerous) display elements 1 via the internal wiring 2 (i.e., the scanning lines 3 and the modulation lines 4).

According to the example illustrated in FIG. 1B, the plural (numerous) scanning wiring terminals 13 are aligned along the Y direction that represents the alignment direction of the scanning lines 3. The plural (numerous) modulation wiring terminals 14 are aligned along the X direction, which represents the alignment direction of the modulation lines 4. The external terminals 12 may be integrated with the internal wiring 2, or may be independently provided as electrically conductive members connected to the internal wiring 2.

As described above, the image display apparatus 100 includes the plural display elements 1, the plural scanning lines 3, the plural modulation lines 4, and the plural external terminals 12. More specifically, the number of the external terminals 12 is equal to or greater than 16 when each of the plurality of signal line groups includes eight or more signal lines.

The number of the display elements 1 maybe determined according to the number of the external terminals 12. Similarly, the number of the external terminals 12 is taken into consideration when the number of the scanning lines 3 and the modulation lines 4, which cooperatively constitute the internal wiring 2, is determined.

In general, the number of the display elements 1 constituting the display panel 10 is equal to or greater than 10,000. The number of the internal wiring 2 (i.e., the scanning lines 3 and the modulation lines 4) and the number of the external terminals 12 are equal to or greater than 100.

As illustrated in FIG. 1A, the image display apparatus 100 includes a control circuit 60, an image processing circuit 70, and a reception circuit 80, in addition to the drive circuit 50. The reception circuit 80 may receive an information signal that includes at least one of image information and text information. The image processing circuit 70 may output a video signal to the control circuit 60 based on the information signal received by the reception circuit 80.

The control circuit 60 may generate a control signal based on the video signal and output the generated control signal to the drive circuit 50 to control the drive circuit 50. The drive circuit 50, as illustrated in FIG. 1B, includes a scanning circuit 30 and a modulation circuit 40. The scanning circuit 30 may output a scanning signal based on a control signal input from the control circuit 60. The modulation circuit 40 may output a modulation signal based on a control signal input from the control circuit 60.

The control signal may include a synchronizing signal. Synchronization between the scanning signal and the modulation signal may be realized by the synchronizing signal. Both the scanning signal and the modulation signal may be collectively referred to as “drive signal.”

The drive signal is an electric signal that may drive the display element 1, when it is input in the display element 1. The drive signal is an analog signal. Both the scanning circuit 30 and the modulation circuit 40 are electronic circuits. A part or the whole of the functions of respective electronic circuits may be realized by an integrated circuit (IC).

The transmitting medium 20 of the image display apparatus 100 includes a transmission line having a resistance component that causes a significant voltage drop. The unevenness in display may be induced when the dispersion in the voltage drop occurs. The influence of the resistance component of the transmission line becomes greater if the scale of the display panel 10 increases. To suppress the unevenness in display, it is desired to shorten the elongated length of each transmission line and suppress the dispersion in the elongated length.

Hence, to reduce the elongated length of each transmission line of the transmitting medium 20 illustrated in FIG. 1A, the transmitting medium 20 may be constituted by a plurality of transmission members 311 dedicated to the scanning signal and a plurality of transmission members 411 dedicated to the modulation signal as illustrated in FIG. 1B.

The scanning wiring terminals 13 are connected electrically and mechanically to the plurality of scanning signal transmission members 311. The scanning circuit 30 is electrically connected to the scanning signal transmission members 311. The scanning signal is transmitted to respective scanning wiring terminals 13 via the scanning signal transmission members 311. The modulation wiring terminals 14 are connected electrically and mechanically to the plural modulation signal transmission members 411. The modulation circuit 40 is electrically connected to the modulation signal transmission members 411. The modulation signal is transmitted to respective modulation wiring terminals 14 via the modulation signal transmission members 411.

The plural transmission members 311 dedicated to the scanning signal are disposed along the Y direction in a mutually spaced relationship. The plural transmission members 411 dedicated to the modulation signal are disposed along the X direction in a mutually spaced relationship. Further, the scanning signal transmission members 311 are spaced from the modulation signal transmission members 411.

The image display apparatus 100 illustrated in FIG. 1B includes two scanning signal transmission members 311 and three modulation signal transmission members 411. However, the transmitting medium 20 is not limited to the example illustrated in FIG. 1B. The transmitting medium 20 may be constructed by two or more scanning signal transmission members 311 and/or two or more modulation signal transmission members 411. It is useful that at least two modulation signal transmission members 411 are included in the transmitting medium 20.

Further, to reduce the elongated length of each transmission line, it is desired that the scanning circuit 30 is constituted by a plurality of scanning ICs 301 as illustrated in FIG. 1B. Further, it is desired that the modulation circuit 40 is constituted by a plurality of modulation ICs 401. In FIG. 1B, respective scanning signal transmission members 311 are connected to the scanning ICs 301 that cooperatively constitute the scanning circuit 30. Further, respective modulation signal transmission members 411 are connected to the modulation ICs 401 that cooperatively constitute the modulation circuit 40.

Next, the transmitting medium 20 is described in detail below with reference to FIGS. 2A and 2B, which are enlarged views illustrating a part of the image display apparatus 100 illustrated in FIG. 1B. FIG. 2A is an enlarged view illustrating a lower left corner of the image display apparatus 100 illustrated in FIG. 1B where the lowermost scanning signal transmission member 311 and the leftmost modulation signal transmission member 411 are positioned next to each other. Namely, FIG. 2A illustrates a lower left corner of the display panel 10 illustrated in FIG. 1B.

FIG. 2B is an enlarged view illustrating an extension area 451 (which is described in detail below) illustrated in FIG. 2A. Hereinafter, a configuration of the center modulation signal transmission member 411 (i.e., one of three modulation signal transmission members 411 illustrated in FIG. 1B) is mainly described. However, a similar configuration may be employed for each of the remaining modulation signal transmission members 411. Further, a similar configuration may be employed for each of the scanning signal transmission members 311. To simplify the following description, each modulation signal transmission member 411 may be simply referred to as a “transmission member 411.”

As illustrated in FIGS. 2A and 2B, each modulation signal transmission member 411 includes n (“n” is a natural number equal to or greater than 8) signal lines 421 and an insulating substrate 431 that supports the signal lines 421. Similarly, each scanning signal transmission member 311 includes a plurality of signal lines 321 and an insulating substrate 331.

The n signal lines 421 are connected, at one end thereof, to the corresponding modulation wiring terminals 14 in a one-to-one relationship. The n signal lines 421 are connected, at the other end, to the modulation IC 401 (i.e., the modulation circuit 40) . Asa result, the modulation circuit 40 is electrically connected to the modulation wiring terminals 14 via the signal lines 421 of the modulation signal transmission member 411. Thus, the modulation signal may be transmitted to respective modulation wiring terminals 14 via the signal lines 421.

Any material, if it may support the n signal lines 421 in a mutually insulated relationship, is usable for the insulating substrate 431. It is desired that the transmission member 411 is a flexible member. For example, a polyimide substrate maybe used to form the insulating substrate 431 when the transmission member 411 is sufficiently flexible. Further, a linear metallic foil (e.g., a copper foil) is usable to form the signal lines 421. In general, a flexible printed circuit (FPC) or a flexible flat cable (FFC) is usable to form the transmission member 411.

As illustrated in FIG. 2A, the modulation IC 401 may be mounted on the insulating substrate 431 using an appropriate, such as Tape Automated Bonding (TAB) or Chip On Film (COF), packaging method. The modulation IC 401 may be mounted on another substrate that is different from the insulating substrate 431. The method for connecting the modulation signal transmission member 411 to respective modulation wiring terminals 14 is not limited to a specific method. For example, an anisotropic conductive film (ACF) is usable if the FPC may be used to form the transmission member 411.

In FIGS. 2A and 2B, the insulating substrate 431 has a left side 4311 positioned on the “−X” side and a right side 4312 positioned on the “+X” side in the alignment direction. In the present exemplary embodiment, the n signal lines supported by one insulating substrate 431, i.e., the n signal lines positioned between the left side 4311 and the right side 4312 of the insulating substrate 431, are collectively referred to as a signal line group.

Numerous signal lines (321, 421) respectively connected to numerous external terminal 12 are constituted by a plurality of signal line groups supported by the insulating substrates (331, 431) of the plural scanning signal transmission members 311 and the plural modulation signal transmission members 411. The number (n≧8) of the signal lines that constitute each of the plurality of signal line groups of the transmitting medium 20 may be arbitrarily set for each signal line group. The number “n” of the signal lines may be a constant value or may be differentiated for each signal line group.

As illustrated in FIG. 2A, the transmission member 411 maybe sectioned into a plurality of areas, in the Y direction, between the left side 4311 and the right side 4312 of the insulating substrate 431. According to the example illustrated in FIG. 2A, the transmission member 411 includes, as plural sectioned areas, a first connection area 441, the extension area 451, a second connection area 461, a packaging area 471, and a connecting area 481.

The first connection area 441 is an area where the signal lines 421 of the transmission member 411 are connected to the modulation wiring terminals 14. The extension area 451 is an area extending from the first connection area 441 to the second connection area 461. The extension area 451 occupies a greater part of the transmission member 411. The second connection area 461 is an area where the signal lines 421 of the transmission member 411 are connected to the modulation IC 401. The packaging area 471 is an area where the modulation IC 401 is mounted. The connecting area 481 is an area where the transmission member 411 is connected electrically or mechanically to another electric (or electronic) circuit, such as the control circuit 60 or a power source circuit.

However, the transmission member 411 according to the present exemplary embodiment is characterized in the configuration of the extension area 451. In this respect, the transmission member 411 includes at least the first connection area 441, the extension area 451, and the second connection area 461. Therefore, the area other than the extension area 451, or any other area (not illustrated), may be appropriately modified, omitted, or added according to the features of each transmission member.

In the extension area 451, the n signal lines 421 constituting a signal line group extend in the same direction (i.e., Y direction) and are aligned in a mutually spaced relationship. More specifically, in the extension area 451, the n signal lines are disposed in parallel with each other. In the present exemplary embodiment, when the angle between two mutually neighboring signal lines is 180±1°, these signal lines are regarded as not intersecting with each other and being in a mutually “parallel” relationship.

The direction along which the plural signal lines 421 are disposed in parallel with each other (i.e., the Y direction in FIGS. 2A and 2B) is referred to as “extension direction.” The direction along which the plural signal lines are aligned (i.e., the X direction in FIGS. 2A and 2B) is referred to as the alignment direction. The alignment direction is a direction perpendicular to the extension direction.

In the following description, as illustrated in FIG. 2B, the signal lines 421 of each signal line group are sequentially referred to as 1st signal line, 2nd signal line, . . . , (n−1)th signal line, and n-th signal line (n is a natural number equal to or greater than 8), from the left side 4311 to the right side 4312. An arbitrary line of the n signal lines 421 that constitute the signal line group is referred to as “k-th (k is a natural number in the range from 1 to n)” signal line. An arbitrary line of the n signal lines 421 that constitute the signal line group is referred to as “j-th” (j is a natural number different from k and in the range from 1 to n) signal line. Namely, the k-th signal line is different from the j-th signal line.

Further, the central line of the n signal lines 421 that constitute the signal line group is referred to as “i-th (i=(n+1)/2)” signal line when “n” is an odd number and is referred to as “i-th (i=n/2)” signal line or “(i+1) th” signal line when “n” is an even number. In FIG. 2B, “1” represents the length of each signal line 421 in the extension direction of the extension area 451, and d[k, j] represents the center-to-center distance between the k-th signal line and the j-th signal line. Further, g[k, j] represents the clearance (i.e., the distance in the alignment direction) between the k-th signal line and the j-th signal line, Wₖ represents the width (i.e., the length in the alignment direction) of the k-th signal line, and Wⱼ represents the width of the j-th signal line. The center-to-center distance d[k, ] is equal to g[k, j]+(Wⱼ+Wₖ)/2.

Dₖ represents a specific center-to-center distance d[k, k+1] between mutually neighboring signal lines. More specifically, Dₖ is the center-to-center distance between the k-th signal line and the (k+1)th signal line. The (k+1)th signal line is a neighboring signal line positioned next to the k-th signal line on the “+X” side closer to the right side 4312.

In the signal line group, no neighboring signal line is present between the n-th signal line and the right side 4312. Therefore, with respect to Dₖ of the n signal lines, k is one of 1 to (n−1). An average center-to-center distance D_{Av} between mutually neighboring signal lines of the n signal lines is represented by d[1, n]/(n−1).

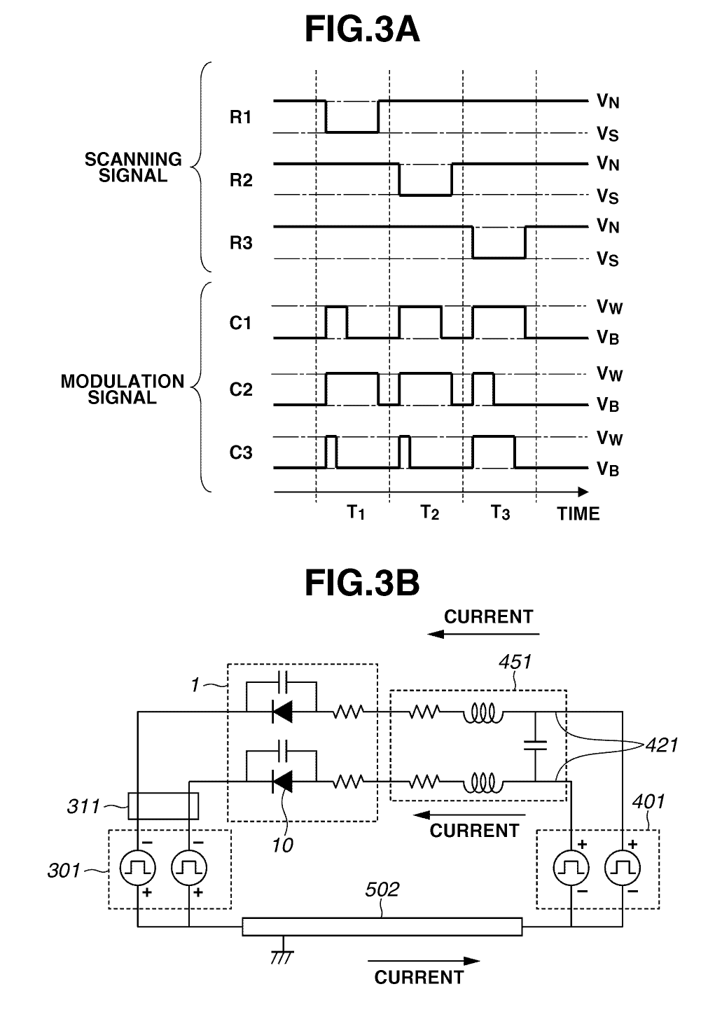

FIG. 3A illustrates an example of drive signals. FIG. 3B illustrates an equivalent circuit of the image display apparatus 100. FIG. 3A illustrates an example of scanning signals supplied to three scanning lines (R1 to R3) sequentially disposed in the Y direction and modulation signals supplied to three modulation lines (C1 to C3) sequentially disposed in the X direction. As illustrated in FIG. 3A, a pulse voltage signal whose potential is time-sequentially switched between a selected potential V_{S} and a non−selected potential V_{N} may be used as the scanning signal.

The scanning circuit 30 applies the selected potential V_{S} to a part (typically one) of the plural scanning lines 3 via the scanning signal transmission member 311 and the scanning wiring terminals 13. The scanning circuit 30 applies the non−selected potential V_{N} to the rest of the plural scanning lines 3. The scanning circuit 30 scans the scanning lines 3, to which the selected potential V_{S} is applied, by time-sequentially switching the scanning lines 3 for each of periods T₁, T₂, and T₃.

As illustrated in FIG. 3A, the modulation signal may be a pulse voltage signal whose waveform is modulated according to the gradation to be displayed by each display element 1 to have at least any potential within the range from a black display potential V_{B} to a white display potential V. FIG. 3A illustrates an example pulse width modulation (PWM) method. As another modulation method, a pulse amplitude modulation (PAM) is employable. Further, it is desired to combine the pulse width modulation and the pulse amplitude modulation as a composite modulation (PWM-PAM).

The modulation circuit 40 simultaneously supplies the voltage pulse to a plurality of (typically all) of the modulation lines 4 via the modulation signal transmission members 411 and the modulation wiring terminals 14. The modulation circuit 40 applies at least any potential in the range from V_{B} to V_{W} to the modulation lines 4 in each of the periods T₁, T₂, and T₃ in synchronization with the timing (periods T₁, T₂, and T₃) when the scanning circuit 30 applies the selected potential V_{S} to the scanning line 3. Thus, the image display apparatus 100 may line-sequentially drive the display elements 1 for respective scanning lines 3.

FIG. 3B illustrates two display elements 1 of the display panel 10 and two (i.e., the k-th and the j-th) signal lines 421 electrically connected to these display elements 1. The k-th signal line and the j-th signal line illustrated in FIG. 3B are positioned in the extension area 451 of the modulation signal transmission member 411. The members illustrated in FIG. 3B are denoted by the common reference numerals if they are similar to those illustrated in FIGS. 1A and 1B and FIGS. 2A and 2B.

As described above, the modulation signal is an electric signal. Therefore, current flows through the signal lines 421 of the transmission member 411, when the transmission member 411 transmits the modulation signal, at least due to the resistance component of the signal lines. Similarly, current flows through the signal lines 321 of the transmission member 311 when the transmission member 311 transmits the scanning signal. According to the example illustrated in FIG. 3B, the current flows from the modulation IC 401 of the modulation signal transmission member 411 to the display panel 10. The current flows from the display panel 10 to the scanning IC 301 of the scanning signal transmission member 311.

At least a part of the current flowing through the transmitting medium 20 and the display panel 10 flows into a conductive member 502, which is a common ground terminal of the scanning IC 301 and the modulation IC 401. A conductive member 502 is, for example, an electrode or a metallic member of the display panel 10, a ground layer of a circuit substrate, a support member of the display panel 10, or a casing of the image display apparatus 100. In the following description, it is presumed that the current flows through all signal lines that constitute a signal line group in the same direction (i.e., the direction from “−Y” to “+Y”) with respect to the extension direction.

As illustrated in FIG. 3A, the drive signal (i.e., the scanning signal or the modulation signal) is an electric signal (or a voltage pulse signal) that causes a change (e.g., rise or fall) in the potential thereof. Therefore, current temporally changing according to a potential change flows through the signal line 421 that transmits the drive signal. Current flowing through the j-th signal line generates a magnetic field.

The k-th signal line generates an induced electromotive force according to a temporal change in the magnetic field. The induced electromotive force generated by the k-th signal line is added, as a noise component, to the drive signal that the k-th signal line transmits. The magnitude of the induced electromotive force caused by an interaction between the k-th signal line and the j-th signal line is proportional to a mutual inductance that the k-th signal lines 421 receives from the j-th signal line.

The mutual inductance is described in detail below. In the present exemplary embodiment, M[k, j] represents the mutual inductance that the k-th signal line of the insulating substrate 431 receives from the j-th signal line, which is referred to as “individual mutual inductance.” The individual mutual inductance M[k, j] may be expressed by the following formula (1).

$$M [ k , j ] = \frac{{μ}_{0}}{2 π} \vert ln ( \frac{\sqrt{{d [ k , j ]}^{2} + {l}^{2}} + l}{d [ k , j ]} ) - \sqrt{{d [ k , j ]}^{2} + {l}^{2}} + d [ k , j ] \vert \qquad ( 1 )$$

In formula (1), μ₀ represents the magnetic permeability of the vacuum. When the center-to-center distance d[k, j] between signal lines becomes shorter, the individual mutual inductance M[k, j] becomes higher. More specifically, when the clearance g[k, j] between signal lines becomes smaller, the individual mutual inductance M[k, j] becomes higher. When the width Wₖ of the signal line becomes smaller, the individual mutual inductance M[k, j] becomes higher.

The mutual inductance Mₖ that the k-th signal line receives from all of the remaining signal lines (i.e., (n−1) signal lines other than the k-th signal line), which is referred to as “entire mutual inductance” of the “k-th signal line” in the present exemplary embodiment, may be expressed as a sum of M[k, j] as defined by the following formula (2).

$${M}_{k} = {\sum }_{j = 1}^{n} M [ k , j ] in which k \neq j . \qquad ( 2 )$$

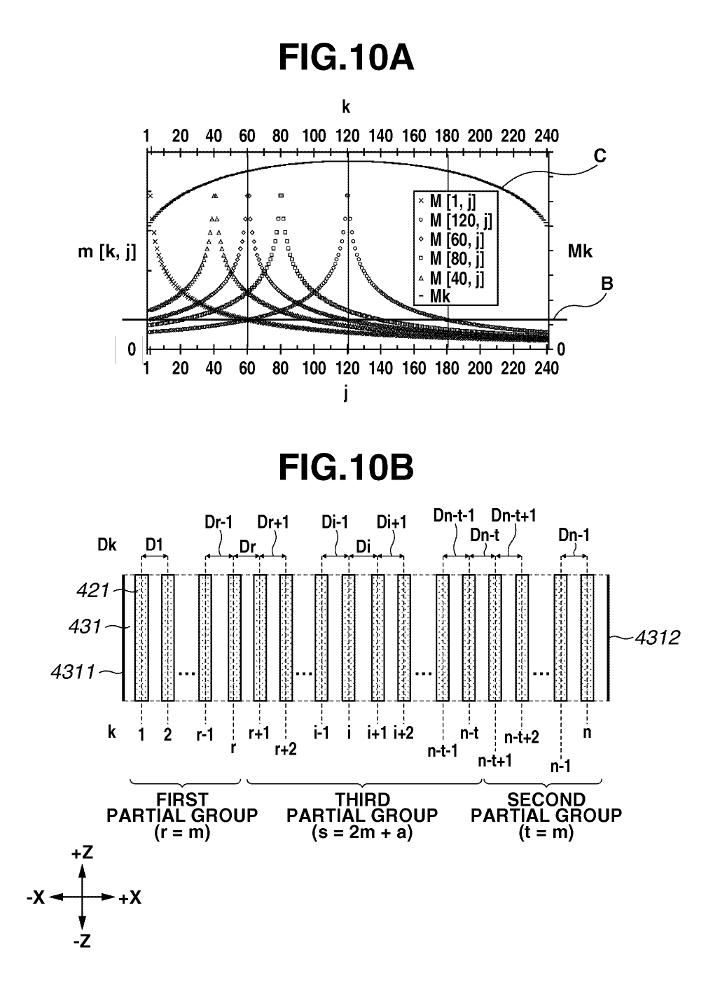

FIG. 10A illustrates an example of the mutual inductance, as a comparative example of the present exemplary embodiment, in which the center-to-center distance between mutually neighboring signal lines of a signal line group composed of 240 signal lines 421 is uniform, more specifically, Dₖ=D_{Av}. FIG. 10A illustrates an example relationship between “j” and M[k, j] and an example relationship between k and Mₖ, when Dₖ is uniform. More specifically, FIG. 10A illustrates M[1, j], M[40, j], M[60, j], M[80, j], and M[120, j] corresponding to k=1, 40, 60, 80, and 120, respectively, as an example relationship between “j” (lower abscissa axis) and M[k, j] (left ordinate axis). Further, FIG. 10A illustrates an example relationship between “k” (upper abscissa axis) and Mₖ (right ordinate axis), in which C is a distribution representing the relationship between “k” and M_{k.}

As understood from FIG. 10A, the individual mutual inductance M[k, j] has a mountain−shaped distribution having a peak value at the position k. The value of M[k, j] monotonically decreases when the difference between “j” and “k” becomes larger. Further, Mₖ has a mountain−shaped distribution having a central region corresponding to the 120th signal line and the 121st signal line. The value of Mₖ monotonically decreases from the central region symmetrically in the right and left direction.

The k-th signal line generates an induced electromotive force proportional to Mₖ of the k-th signal line due to a change in the current flowing through the remaining (n−1) signal lines other than the k-th signal line. In the following description, Vₖ represents an induced electromotive force generated by the k-th signal line due to a change in the current flowing through the remaining signal lines of the same signal line group other than the k-th signal line.

Then, when the current change occurs simultaneously in the n signal lines of a signal line group, a distribution of Vₖ similar to the distribution C of Mₖ appears in the signal line group. Therefore, as a typical phenomenon, the luminance of a display element 1 electrically connected to a signal line positioned in the vicinity of the center of each signal line group becomes different from the luminance of a display element 1 electrically connected to a signal line positioned in the vicinity of the end of the signal line group. An observer (i.e., a user) of the image display apparatus 100 recognizes such a phenomenon as unevenness in display (i.e., unevenness in luminance).

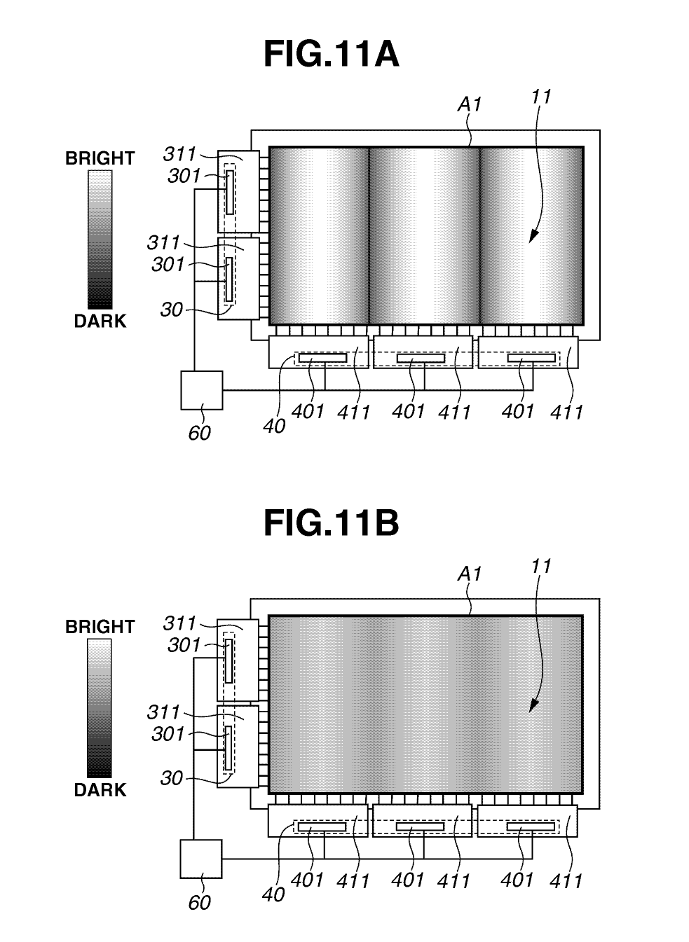

FIG. 11A illustrates an example of bright/dark unevenness periodically appearing on the display screen 11 of the display panel 10 described with reference to FIG. 1B, which corresponds to respective modulation signal transmission members 411. The display unevenness illustrated in FIG. 11A is obtainable when the display elements 1 are disposed in a matrix pattern and the internal wiring 2 is a matrix wiring. Another display unevenness different from the example illustrated in FIG. 11A may appear if the display elements 1 are changed in their characteristics or alignment or if the internal wiring 2 is changed in alignment.

The above-described display unevenness becomes greater when the gradation of a modulation signal supplied to each of the modulation wiring terminals 14 from the modulation circuit 40 is the same. On the other hand, if the modulation signals supplied to respective modulation wiring terminals 14 from the modulation circuit 40 are mutually differentiated in gradation to display an intended image, the display unevenness may be suppressed to a certain extent although the presence of the unevenness is visually recognized.

Through an elaborate study on the M[k, j] and Mₖ distributions illustrated in FIG. 10A, it is revealed that the tendency of the Mₖ distribution changes greatly at the boundary between the 60th signal line and the 61st signal line as well as the boundary between the 180th signal line and the 181st signal line. More specifically, the left-hand signal lines positioned between the left side 4311 and the 61st signal line have attenuated Mₖ (k=1 to 60) values that are extremely lower compared to the maximum values M₁₂₀ and M₁₂₁ of Mₖ.

Similarly, the right-hand signal lines positioned between the 180th signal line and the right side 4312 have attenuated Mₖ (k=181 to 240) values that are extremely lower compared to the maximum values M₁₂₀ and M₁₂₁ of Mₖ. The above-described left-hand and right-hand signal lines may be simply referred to as “signal lines having lower Mₖ values.”

On the other hand, the central signal lines positioned between the 60th signal line and the 181st signal line have higher Mₖ values comparable to the maximum values M₁₂₀ and M₁₂₁ of Mₖ. Further, a dispersion of Mₖ among the central signal lines is sufficiently smaller compared to the entire dispersion of Mₖ in the signal line group. In this respect, the central signal lines may be simply referred to as “signal lines having smaller dispersion in Mₖ value.”

The above-described boundary may be easily understood when only the individual mutual inductance M[k, j ] in the region above a straight line B illustrated in FIG. 10A is taken into consideration. More specifically, an approximate Mₖ distribution may be obtained by discarding the signal lines whose M[k, j] value is lower than the straight line B. In the present exemplary embodiment, the straight line B represents a minimum value (M[120,60]=M[120,180]) of the individual mutual inductance that the 120th signal line receives from the remaining central 120 signal lines, i.e., the 60th to 119th signal lines and the 121st to 180th signal lines. In the illustrated example, a relationship M[120,60]=M[120,180]=M[1, 61]=M[40, 100]=M[61, 1]=M[61, 121]=M[80,20]=M[80, 140]=M[120,60] may be recognized.

According to the above-described formula (2), it is feasible to replace the mutual inductance Mₖ by an area between the M[k, j] distribution shape illustrated in FIG. 10A and the lower abscissa axis (M[k, j=0]). As understood from the M[k, j] distribution above the straight line B illustrated in FIG. 10A, the distribution shape of each of M[1, j], M[40, j], and M[60, j] is asymmetric in the right and left direction. The area between each distribution shape and the lower abscissa axis is different.

On the other hand, in the region of M[k, j] above the straight line B, the distribution shape of each of M[61, j], M[80, j], and M[120, j] is symmetric in the right and left direction, The area between each distribution shape and the straight line B is similar. More specifically, in the region above the straight line B, the area of M[61, j] is larger than the area of M[1, j] by an amount of M[61, 1] to M[61, 60]. Further, in the region above the straight line B, the area of M[61, j] is larger than the area M[60, j] by an amount of M[61,1].

As described above, Mₖ corresponding to the area between the distribution shape of M[k, j] in the region above the straight line B and the lower abscissa axis may be approximated as being constant in the range 61≦k≦120 when the boundary is set between the 60th signal line and the 61st signal line. Due to the symmetry of the Mₖ distribution, Mₖ may be approximated as being constant in the range 120≦k≦180. More specifically, Mₖ of 120 signal lines in the range 61≦k≦180, of 240 signal lines, may be approximated as being constant.

Hence, in the case where Dₖ is constant, the signal line group may be classified into a plurality of partial groups in the following manner with respect to the plurality of signal lines having lower Mₖ values and the plurality of signal lines having smaller dispersion in Mₖ value. More specifically, as illustrated in FIG. 10B, the first partial group and the second partial group may be defined as a partial group of a plurality of signal lines having lower Mₖ values. Further, the third partial group may be defined as a partial group of a plurality of signal lines having smaller dispersion in Mₖ value.

The first partial group is a partial group that includes the 1st signal line of the signal line group. The second partial group is a partial group that includes the n-th signal line of the signal line group. The third partial group is a partial group positioned between the first partial group and the second partial group. The third partial group is a partial group that includes the central signal line (i.e., the i-th signal line when “n” is an odd number and the i-th and (i+1)th signal lines when “n” is an even number) of the signal line group.

To simplify the following description, “r” represents the number of signal lines that constitute the first partial group, “t” represents the number of signal lines that constitute the second partial group, and “s” represents the number of signal lines that constitute the third partial group. The first partial group is composed of “r” signal lines sequentially aligned from the left side of the insulating substrate 431. More specifically, the first partial group includes the 1st signal line to the r-th signal line.

The second partial group is composed of “t” signal lines sequentially aligned from the right side of the insulating substrate 431. More specifically, the second partial group includes the n-th signal line to the (r+s+1(=n−t+1))th signal line. The third partial group is composed of s(s=n −r−t) signal lines. More specifically, the third partial group includes the (r+1)th signal line to the (r+s(=n −t))th signal line.

A signal line group composed of 240 signal lines includes 120 (=½×240) signal lines having smaller dispersion in Mₖ value. The signal lines having lower Mₖ values are classified into 60 signal lines positioned on one side (adjacent to the left side 4311) of the above-described 120 signal lines and 60 signal lines positioned on the other side (adjacent to the right side 4312) of the above-described 120 signal lines.

In the signal line group including n signal lines, if n is a multiple of 4, it may be generalized that n/2 signal lines have smaller dispersion in Mₖ value. Further, it may be generalized that n/4 signal lines positioned on one side (adjacent to the left side 4311) of the above-described signal lines n/2 have lower Mₖ values. Similarly, it may be generalized that n/4 signal lines positioned on the other side (adjacent to the right side 4312) of the above-described signal lines n/2 have lower Mₖ values. The above-described generalization is based on the symmetry of M[k, j] with respect to k illustrated in FIG. 10A.

Hence, it is desired to set the above-described parameters “r”, “s”, and “t” in such a way as to satisfy a relationship r:s:t=1:2:1. More specifically, the total number of the signal lines constituting the third partial group is approximately equal to a half of all signal lines constituting the signal line group. Further, the segmentation of respective partial groups is symmetrical in the signal line group.

To correctly describe the first to third partial groups, it is now presumed that the total number “n” of the signal lines that constitute a signal line group is equal to 4m+a, i.e., n=4m+a, in which “m” is an arbitrary natural number equal to or greater than 2 and “a” is any one of 0, 1, 2, and 3. It is feasible to define each of the first to third partial groups even when “n” is not a multiple of 4.

For example, if the total number “n” of the signal lines is 240 (i.e., n=240), the parameter “m” is equal to 60 (i.e., m=60) and the parameter “a” is equal to 0 (i.e., a=0). If the total number “n” of the signal lines is 242 (i.e., n=242), the parameter “m” is equal to 60 (i.e., m=60) and the parameter “a” is equal to 2 (i.e., a=2) . Further, the total number “r” of the signal lines that constitute the first partial group is equal to m (i.e., r=m) . The total number “t” of the signal lines that constitute the second partial group is equal to m (i.e., t=m) . Further, the total number “s” of the signal lines that constitute the third partial group is equal to 2m+a (i.e., s=(2m+a)) .

If the total number “n” of the signal lines is 240 (i.e., n=240), the first partial group is composed of 60 signal lines. The second partial group is composed of 60 signal lines. The third partial group is composed of 120 signal lines. The maximum rate of the signal lines constituting the third partial group of the signal line group is approximately 63.6% when n=11. In a practical range n≧40 (m≧10) with respect to the number of signal lines that constitute the signal line group, the rate of the signal lines constituting the third partial group is equal to or greater than 50% and equal to or less than 53.5%. When the total number “n” of the signal lines becomes larger, the rate of the signal lines constituting the third partial group converges at 50%. As described above, the number of the signal lines that constitute the third partial group may be practically regarded as a half of the total number of the signal lines that constitute the signal line group.

Table 1 illustrate example combinations with respect to the number of signal lines (n=4m+a) that constitute a signal line group, which may be determined according to the above-described definition, together with example values of the parameters (r, s, t) representing the signal lines that constitute respective partial groups.

TABLE 1

| n | m | a | r | s | t | s/n(%) |
|---|---|---|---|---|---|---|
| 8 | 2 | 0 | 2 | 4 | 2 | 50.0 |
| 9 | 2 | 1 | 2 | 5 | 2 | 55.6 |
| 10 | 2 | 2 | 2 | 6 | 2 | 60.0 |
| 11 | 2 | 3 | 2 | 7 | 2 | 63.6 |
| 12 | 3 | 0 | 3 | 6 | 3 | 50.0 |
| 13 | 3 | 1 | 3 | 7 | 3 | 53.8 |
| 14 | 3 | 2 | 3 | 8 | 3 | 57.1 |
| 15 | 3 | 3 | 3 | 9 | 3 | 60.0 |
| 40 | 10 | 0 | 10 | 20 | 10 | 50.0 |
| 41 | 10 | 1 | 10 | 21 | 10 | 51.2 |
| 42 | 10 | 2 | 10 | 22 | 10 | 52.4 |
| 43 | 10 | 3 | 10 | 23 | 10 | 53.5 |
| 240 | 60 | 0 | 60 | 120 | 60 | 50.0 |
| 241 | 60 | 1 | 60 | 121 | 60 | 50.2 |
| 242 | 60 | 2 | 60 | 122 | 60 | 50.4 |
| 243 | 60 | 3 | 60 | 123 | 60 | 50.6 |

As described above, the signal lines that belong to a signal line group maybe sectioned into three partial groups. Thus, a plurality of signal lines having lower Mₖ values may be appropriately discriminated from the signal lines having smaller dispersion in Mₖ value. If the number of signal lines that constitute the signal line group becomes larger, the Mₖ value of each signal line constituting the first and second partial groups tends to become lower and the dispersion in Mₖ value of each signal line constituting the third partial group tends to become smaller.

As described above, when the signal line group is sectioned into three partial groups, it is feasible to obtain the center-to-center distance Dₖ having a binary or more value for each partial group.

In the present exemplary embodiment, to reduce the display unevenness that may be caused by the Mₖ distribution, the center-to-center distance Dₖ between mutually neighboring signal lines of the signal line group is not uniform (i.e., ununiform). Hence, a statistical representative value (e.g., medium value, average value, minimum value, or maximum value) is usable to regulate the ununiformity in the Dₖ distribution.

As example values representing the signal line group, it is feasible to regulate a maximum value D_{Max} and a minimum value D_{MIN} of D₁ to Dₙ₋₁. The maximum value D_{Max} is greater than the average center-to-center distance D_{AV} (D_{Max}/D_{Av}>1), and the minimum value D_{MIN} is smaller than D_{AV} (D_{MIN}/D_{AV}<1).

It is feasible to obtain the center-to-center distance Dₖ (=D₁ to Dᵣ) between r signal lines (i.e., 1st to r-th signal lines) of the first partial group and neighboring right-hand signal lines (i.e., 2nd to (r+1)th signal line), which are respectively positioned adjacent to the right side 4312 (or the second partial group or the third partial group) compared to the r signal lines constituting the first partial group.

For example, the (r−1)th signal line and the (r+1)th signal line are two neighboring signal lines positioned next to the r-th signal line. More specifically, the (r−1)th signal line is one neighboring signal line positioned on the left side of the r-th signal line. The (r+1)th signal line is the other neighboring signal line positioned on the right side of the r-th signal line. Further, as example values representing the first partial group, it is feasible to regulate a medium value D_{Me1}, an average value D_{Av1} a minimum value D_{Min1}, and a maximum value D_{Max1} of D₁ to Dᵣ.

It is feasible to obtain the center-to-center distance Dₖ (=Dₙ₋ₜ to Dₙ₋ₗ) between t signal lines (i.e., (n−t+1)th to n-th signal lines) of the second partial group and neighboring left-hand signal lines (i.e., (n−t) th to (n−1) th signal lines), which are respectively positioned adjacent to the left side 4311 (or the first partial group or the third partial group) compared to the t signal lines constituting the second partial group.

For example, the (n−t)th signal line and the (n−t+2)th signal line are two neighboring signal lines positioned next to the (n−t+1)th signal line. More specifically, the (n−t) th signal line is one neighboring signal line positioned on the left side of the (n−t+1)th signal line. The (n−t+2)th signal line is the other neighboring signal line positioned on the right side of the (n−t+1)th signal line. Further, as example values representing the second partial group, it is feasible to regulate a medium value D_{Me2}, an average value D_{Av2} a minimum value D_{Min2}, and a maximum value D_{Max2} of Dₙ₋ₜ to Dₙ₋₁.

It is feasible to obtain the center-to-center distance Dₖ (=Dᵣ₊₁ to Dₙ₋ₜ₋₁) between mutually neighboring signal lines (i.e., (r+2)th to (n−t-1)th signal lines) of s signal lines (i.e., (r+1)th to (n−t)th signal lines) that constitute the third partial group.

For example, the r-th signal line and the (r+2)th signal line are two neighboring signal lines positioned next to the (r+1)th signal line of the third partial group. In this case, the signal line that belongs to the third partial group is the (r+2)th signal line, not the r-th signal line.

Further, as example values representing the third partial group, it is feasible to regulate a medium value D_{Me3}, an average value D_{Av3}, a minimum value D_{Min3}, and a maximum value D_{Max3} of Dᵣ₊₁ to Dₙ₋ₜ₋₁. The expression “mutually neighboring signal lines of s signal lines that constitute the third partial group” indicates that Dᵣ and Dₙ₋ₜ are not regarded as representative values of the third partial group because Dᵣ and Dₙ₋ₜ are involved as representative values of the first partial group and the second partial group, respectively.

The medium value is a representative value that may be referred to as a median or an intermediate value. The medium value represents a value of the data positioned at the center of the data distribution when countable data (e.g., the center-to-center distance Dₖ) are sequentially disposed in ascending order. If the total number of the countable data is an odd number, the medium value represents a value of the ((number of data+1)/2)th data. If the total number of the countable data is an even number, the medium value represents an arithmetical mean of the ((number of data)/2)th data and the (1+(number of data)/2))th data.

In the present exemplary embodiment, to reduce the display unevenness that may be caused by the Mₖ distribution, the center-to-center distance Dₖ of mutually neighboring signal lines of a signal line group has a distribution that satisfies a condition (A) D_{Me1}<D_{Me3} and D_{Me2}<D_{Me3}. When the center-to-center distance Dₖ satisfies the condition (A), it is feasible to suppress the phenomenon that the mutual inductance Mₖ of the signal lines belonging to the first partial group or the second partial group becomes extremely lower compared to the mutual inductance Mₖ of the signal lines belonging to the third partial group.

Therefore, it is feasible to reduce the dispersion in Mₖ value that may arise in the signal lines of the signal line group. In the context of the present specification, the expression “reduce the dispersion in Mₖ value” means that, if the Dₖ distribution of a signal line group having a predetermined D_{Av} satisfies the above-described condition (A), the standard deviation of the mutual inductance Mₖ becomes smaller compared to a case where the Dₖ value is equal to the D_{Av} value (i.e., a constant value).

As a result, the image display apparatus according to the present exemplary embodiment may reduce the dispersion in Vₖ value that may arise in the signal lines 421. Further, the image display apparatus according to the present exemplary embodiment may reduce (suppress) the display unevenness that may appear on the display panel 10. More specifically, when the modulation signal indicating the same gradation is input to all signal lines connected to the modulation wiring terminals 14, the dispersion in luminance of the display panel 10 becomes smaller compared to the case where the Dₖ value is constant.

FIG. 11B illustrates an example of bright/dark unevenness periodically appearing on the display screen 11, which corresponds to respective modulation signal transmission members 411. As understood from the comparison between two examples illustrated in FIGS. 11A and 11B, it is feasible to reduce the unevenness in display.

The center-to-center distance Dₖ between signal lines may be set by reducing the clearance between the k-th signal line and the (k+1)th signal line. Further, it is feasible to adjust the mutual inductance Mₖ by setting an appropriate distribution with respect to the width Wₖ (thickness) of the signal lines. However, if the distribution is present with respect to the width Wₖ of the signal lines, resistance components of the signal lines will have a distribution correspondingly. Therefore, it is desired that respective signal lines belonging to the same signal line group are uniform in width W_{k.}

Further, in addition to the condition (A) that uses the medium values, it is desired that a condition (B) D_{Av1}<D_{Av3} and D_{Av2}<D_{Av3} is satisfied with respect to the average value. The average values D_{Av1}, D_{Av2}, and D_{Av3} are variable and the individual mutual inductance M[k, j] changes correspondingly even when only two mutually neighboring signal lines of a signal line group are slightly differentiated from other signal lines in the center-to-center distance.

However, as described above, the individual mutual inductance Mₖ may be expressed as a sum of M[k, j]. Therefore, when a signal line group includes numerous signal lines, the Mₖ distribution does not substantially change even if the signal line group satisfies the condition (B) without satisfying the condition (A). Therefore, it is desired to satisfy both the condition (A) and the condition (B).

It is useful to satisfy a condition (C) D_{Min1}<D_{Min3} and D_{Min2}<D_{Min3} and a condition (D) D_{Max1}<D_{Max3} and D_{Max2}<D_{Max3}, in addition to the condition (A), with respect to the minimum value and the maximum value. Further, it is desired to satisfy a condition (E) D_{Max1}<D_{Min3} and D_{Max2}<D_{Min3}. The condition (E) automatically satisfies the conditions (A) to (D).

Similar to the average value, the minimum value and the maximum value are variable and the individual mutual inductance M[k, j] changes correspondingly even when only two mutually neighboring signal lines of a signal line group are slightly differentiated from other signal lines in the center-to-center distance. However, the Mₖ distribution does not change so greatly. Therefore, it is desired to satisfy the condition (A) and the condition (C), or the condition (D), or the condition (E). It is useful to satisfy the condition (A), the condition (B) and the condition (C), or the condition (D), or the condition (E).

Further, it is desired to satisfy a relationship D_{Min1}=D₁=d[1, 2] and D_{Min2}=Dₙ₋₁=d[n−1, n]. This is effective to increase M₁ and Mₙ of the 1st signal line and the n-th signal line (i.e., the signal lines whose Mₖ values tend to become lower) of the signal line group. Further, when the total number “n” is an odd number, it is desired to satisfy a relationship D_{Max3}=Dᵢ. When the total number “n” is an even number, it is desired to satisfy a relationship D_{Max3}=Dᵢ and/or Dᵢ₊₁. It is effective to lower the entire mutual inductance Mᵢ (and Mᵢ₊₁) of the signal line(s) positioned at the center of the signal line group (i.e., the signal lines whose entire mutual inductance tends to become higher) of the signal line group.

It is desired that the Dₖ value monotonically decreases in broad sense from the signal line (s) positioned at the center of the signal line group toward the 1st signal line. It is further desired that the Dₖ value monotonically decreases in narrow sense. Further, it is desired that the Dₖ value monotonically decreases in broad sense from the signal line (s) position at the center of the signal line group toward the n-th signal line. It is further desired that the Dₖ value monotonically decreases in narrow sense.

When the Dₖ value monotonically decreases in narrow sense from the signal line(s) positioned at the center toward the both ends, all of the conditions (A) to (E) maybe satisfied. As described with reference to FIG. 10A, there is the tendency that the Mₖ distribution monotonically decreases in narrow sense from the center. Therefore, it is feasible to accurately reduce the dispersion in Mₖ value by setting the distribution of the center-to-center distance in such a way as to monotonically decrease in narrow sense from the center.

Further, in the extension area 451, it is desired that the alignment of the signal lines constituting a signal line group is line-symmetric about the central signal line of the signal line group in the alignment direction, because the display unevenness appearing in the entire internal area may be decreased. Even if the alignment of the signal lines constituting a signal line group is not completely line-symmetric, it is desired to satisfy at least one of D_{Me1}=D_{Me2}, D_{Av1}=D_{Av2}, and D_{Min1}=D_{Min2} in addition to the condition (A).

As described above, when the condition (A) is satisfied, the dispersion in Mₖ value may be reduced and the display unevenness may be suppressed. However, for example, when the Dₖ value of the first and second partial groups becomes extremely smaller and the Dₖ value of the third partial group becomes extremely greater, the Mₖ value of the signal lines belonging to the first partial group and the second partial group becomes extremely higher compared to the Mₖ value of the signal lines belonging to the third partial group.

When the ratio of the Dₖ value of the first and second partial groups to the Dₖ value of the third partial group increases, there is a tendency that the Mₖ value of the third partial group does not change so much while the Mₖ value of the first and second partial groups increases monotonically. As a result, compared to a case where the Dₖ value is constant, the dispersion in Mₖ value deteriorates (i.e., the dispersion becomes larger) and another display unevenness different (e.g., reversed in bright/dark) from the display unevenness illustrated in FIG. 11A may appear.

Therefore, Dₖ is set in such a way that the luminance of a plurality of display elements 1 connected to the signal lines belonging to the first and the second partial groups becomes equal to the luminance of a plurality of display elements 1 connected to the signal lines belonging to the third partial group.

More specifically, Dₖ is set within a range where the standard deviation of the luminance of a plurality of display elements connected to the signal lines that constitute the signal line group becomes smaller, compared to the alignment of Dₖ=D_{Av}. However, the deterioration condition with respect to the dispersion in Mₖ value is variable depending on the width Wₖ of each signal line, the distribution of Dₖ, and the length l of the extension area 451. Therefore, the deterioration condition with respect to the dispersion in Mₖ value may not be unequivocally defined.

However, it was confirmed through a trial of various settings that the dispersion in Mₖ value maybe reduced compared to the case where Dₖ is constant if a condition (F) 1<D_{Max}/D_{Min}≦50 is satisfied. Accordingly, to reduce the unevenness in display, it is effective to satisfy the condition (A) and the condition (F). Further, if a condition (G) 2<D_{Max}/D_{Min}≦10 is satisfied, the dispersion in Mₖ value may be appropriately reduced. There is a tendency that the maximum value of Mₖ is saturated when D_{Max} increases. The Mₖ distribution is substantially determined by D_{Min}. When the condition (F) is satisfied, a relationship 1>D_{Min}/D_{Av}≧0.05 maybe established. However, D_{Min} is substantially restricted by the width of each signal line. Therefore, it is desired that a condition (H) 1>D_{Min}/D_{Av}≧0.1 is satisfied.

A phenomenon similar to the above-described phenomenon that causes a distribution in Mₖ value may arise in the scanning signal transmission member 311. However, the current of the scanning signal flowing through many of the signal lines 321 to which the non−selected potential V_{N} is applied is very small compared to the current flowing through a part of the signal lines 321 to which the selected potential V_{S} is applied. Therefore, the signal lines 321 of the scanning signal transmission member 311 generate a smaller induced electromotive force Vₖ.

Further, the influence of the Mₖ distribution in the scanning signal transmission member 311, i.e., the dispersion in Vₖ value, is smaller compared to that in the modulation signal transmission member 411. Therefore, the display unevenness in each of the scanning lines 3 connected to respective scanning wiring terminals 13 is smaller compared to the display unevenness in each of the modulation lines 4. Accordingly, applying embodiments of the present invention to the scanning signal transmission member 311 is not essentially required. Even when embodiments of the present invention are applied to only the modulation signal transmission member 411, the unevenness in display may be sufficiently reduced.

In the above-described embodiment, the current flows through the signal lines 421 of the signal line group in the same direction. In general, as described with reference to FIG. 1, the transmission members (i.e., the scanning signal transmission member 311 and the modulation signal transmission member 411) are separately provided for each of the scanning circuit 30 and the modulation circuit 40. In this case, the current flows through all of the signal lines (321, 421) that constitute the signal line group in the same direction. Therefore, the effects of embodiments of the present invention may be sufficiently obtained.

On the other hand, if a single transmission member is connected to both the scanning circuit 30 and the modulation circuit 40, the current flows through apart of the signal lines of the signal line group in the opposite direction compared to the current flowing though other signal lines. According to such a configuration, a magnetic field generated by the current may be canceled by a magnetic field generated by the opposite current. Therefore, the dispersion in Vₖ value is comparatively small. The unevenness in display may be reduced.

Providing a plurality of modulation signal transmission members 411 in a mutually spaced relationship is effective to reduce the influence of the mutual inductance between neighboring modulation signal transmission members 411. Further, it is desired that the clearance between a signal line group of a modulation signal transmission member 411 and a signal line group of a neighboring modulation signal transmission member 411 positioned adjacent to the left side 4311 is equal to or greater than d [1, r] of the modulation signal transmission member 411. This setting is useful to greatly reduce the influence of the mutual inductance between two modulation signal transmission members 411.

In this case, d[1, r] represents the center-to-center distance between two edge signal lines (i.e., the 1st signal line and the r-th signal line) of the first partial group. Further, it is desired that the clearance between signal line groups of mutually neighboring modulation signal transmission members 411 is equal to or greater than a quarter of the center-to-center distance d[1, n] of two edge signal lines of the signal line group.

If there are two or more different values with respect to the center-to-center distance d[1, n] of mutually neighboring modulation signal transmission members 411, it is useful to employ a larger value. When the clearance between signal line groups of mutually neighboring modulation signal transmission members 411 is equal to or greater than d[1, n]/4, it is feasible to substantially discard the influence of mutually neighboring modulation signal transmission members 411.

Next, an exemplary embodiment capable of bringing effects according to the present invention is described.

When the current flowing through signal lines is large, and when a change amount of the current flowing through signal lines is large, a greater dispersion occurs in Mₖ or Vₖ value. When the current flowing through the display elements 1 has a strong correlation with the luminance of the display elements 1, and when the potential of the drive signal has a strong relationship with the luminance, the unevenness in display becomes greater.

An example of the display element 1 to which an embodiment of the present invention may be applied is, for example, a cathode luminescence device that includes a fluorescent member and an electron emission device that may emit an electron beam toward the fluorescent member. Another example of the display element 1 is an electroluminescence device that includes an organic light emitting layer and a semiconductor junction.

Further, another example of the display element 1 is a photoluminescence device that includes a fluorescent member and a gas-discharge element that may emit light toward the fluorescent member, or a liquid crystal element. Further, if necessary, a switching device including active elements (e.g., thin film transistors) may be used to connect these display elements 1 to the internal wiring 2. In this case, it is feasible to drive numerous display elements 1 by the active matrix drive.

Among the above-described examples of the display element 1, the cathode luminescence device and the electroluminescence device are examples of the current drive type display element. The current drive type display element is generally characterized in that the current flowing through signal lines is relatively large, compared to that of a voltage drive type display element (e.g., the liquid crystal element). Further, the current drive type display element is characterized in that the current flowing through the display elements 1 has a strong correlation with the luminance of the display elements 1. Accordingly, it is effective to apply an embodiment of the present invention to the image display apparatus 100 that includes cathode luminescence devices or electroluminescence devices as the display elements 1.

Further, if the modulation signal is a PWM signal, the change amount of the current flowing through signal lines may be maintained at a constant level irrespective of the luminance of the display. Accordingly, if an image is displayed based on the PWM modulation signal, the change amount of the current flowing through signal lines tends to become larger, compared to a case where the modulation signal is a PAM signal. Accordingly, it is effective to apply an embodiment of the present invention to the image display apparatus 100 including the modulation circuit 40 that outputs a PWM modulation signal.

If the display elements 1 are connected to the matrix wiring (i.e., the internal wiring 2) without using any switching element, numerous display elements 1 may be driven by the passive matrix drive (i.e., simple matrix drive). According to the passive matrix drive, the display elements 1 are driven according to a drive voltage that represents a potential different between the scanning signal and the modulation signal. Therefore, the potential of the drive signal (especially, the modulation signal) has a strong relationship with the luminance. Accordingly, it is effective to apply an embodiment of the present invention to the image display apparatus 100 that employs the passive matrix drive.

A field emission display (FED) that uses cathode luminescence devices as the display elements 1 is usable as an example of the image display apparatus 100 that may obtain desired effects according to an embodiment of the present invention. The field emission display may appropriately perform the passive matrix drive due to non-linear characteristics of the electron emission device. Therefore, desired effects may be obtained when an embodiment of the present invention is applied to the field emission display that performs the passive matrix drive.

Next, exemplary embodiments of the present invention are described below. In the following description, it is presumed that “n” is an even number.

### First Exemplary Embodiment

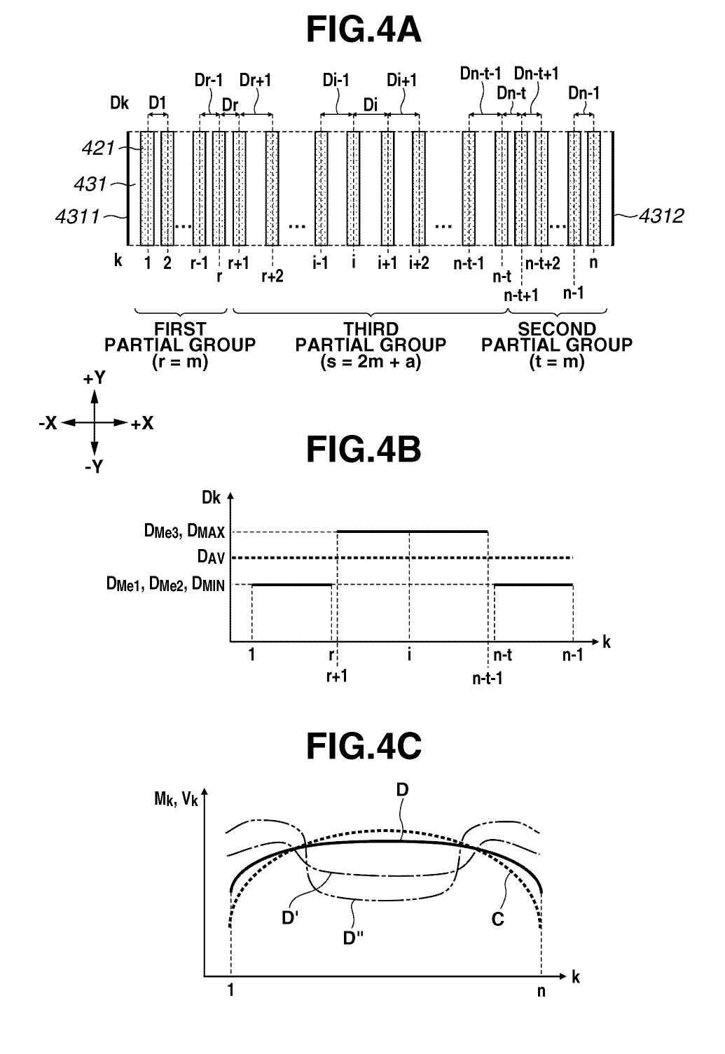

FIG. 4A is an enlarged view illustrating the extension area 451 of the transmission member 411. In the extension area 451, n signal lines are disposed in parallel to each other. The average center-to-center distance D_{Av} in the present exemplary embodiment is similar to that in the wiring configuration illustrated in FIGS. 10A and 10B.

FIG. 4B is a graph illustrating an example distribution of the center-to-center distance Dₖ of the signal lines illustrated in FIG. 4A. The center-to-center distances D₁ to Dᵣ between the 1st to r-th signal lines of the first partial group and their neighboring signal lines are constant. The center-to-center distances Dₙ₋ₜ to Dₙ₋₁ between the (n−t+1)th to n-th signal lines of the second partial group and their neighboring signal lines are constant. The center-to-center distances Dᵣ₊₁ to between the (r+1)th to (n−t)th signal lines of the third partial group and their neighboring signal lines are constant.

Further, the example distribution illustrated in FIG. 4B satisfies a relationship D₁ to Dᵣ, Dₙ₋ₜ to Dₙ₋₁<Dᵣ₊₁ to Dₙ₋ₜ₋₁. The n signal lines are uniform in width. Accordingly, the example distribution illustrated in FIG. 4B satisfies the above-described conditions (A) and (B). Further, the distribution monotonically decreases in broad sense from the center of the signal line group and is line-symmetric about the center. Accordingly, the example distribution illustrated in FIG. 4B satisfies a relationship D_{Me1}=D_{Me2}=D_{Min} and D_{Me3}=D_{Max}.

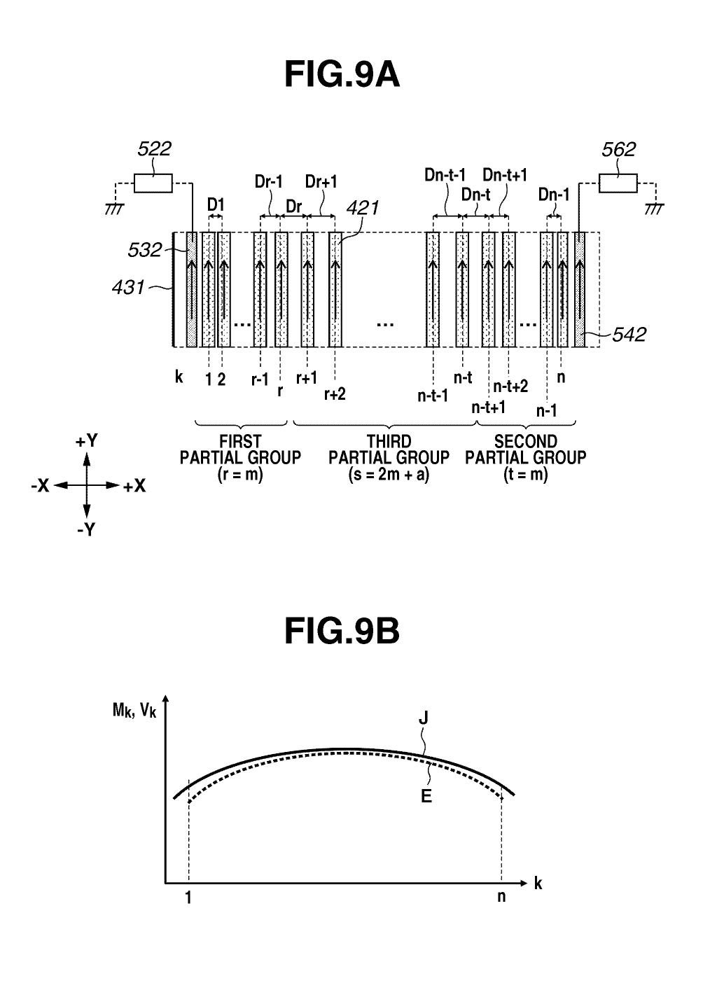

FIG. 4C includes a solid line D that indicates an example Mₖ distribution obtainable by the wiring configuration illustrated in FIGS. 4A and 4B. FIG. 4C further includes a dotted line C that indicates a comparative Mₖ distribution obtainable by the wiring configuration illustrated in FIGS. 9A and 9B. It is understood from FIG. 4C that the dispersion in Mₖ value may be reduced and, as a result, the dispersion in Vₖ value may be reduced.

An alternate long and short dash line D′ indicates the difference between D_{Me3} and D_{Me1} or D_{Me2} (i.e., the difference between D_{Min} and D_{Max}), which is enlarged compared to the example indicated by the solid line D. According to the alternate long and short dash line D′, the difference between the maximum value and the minimum value of Mₖ is smaller compared to that of the solid line D. Thus, the dispersion in Mₖ value is reduced compared to that of the solid line D.

Further, the alternate long and short dash line D′ has an M-shaped configuration. More specifically, the Mₖ distribution is not a mountain−shaped distribution (see the solid line D). The above-described configuration is effective to reduce the period of the unevenness in display and suppress the display unevenness that may be visually recognized.

An alternate long and two short dashes line D″ indicates the difference between D_{Me3} and D_{Me1} or D_{Me2} (i.e., the difference between (D_{Min} and D_{Max}), which is further enlarged compared to the example indicated by the alternate long and short dash line D′. According to the alternate long and two short dashes line D″, the Mₖ distribution has an M-shaped configuration. It becomes feasible to suppress the display unevenness that may be visually recognized.

However, according to the alternate long and two short dashes line D″, the difference between the maximum value and the minimum value of Mₖ is larger compared to that of the alternate long and short dash line D′. Further, if the difference between D_{Min} and D_{Max} is increased, the dispersion in Mₖ value may deteriorate compared to that of the dotted line C (i.e., the example in which Dₖ is constant). Therefore, it is necessary to appropriately set the Dₖ distribution.

### Second Exemplary Embodiment

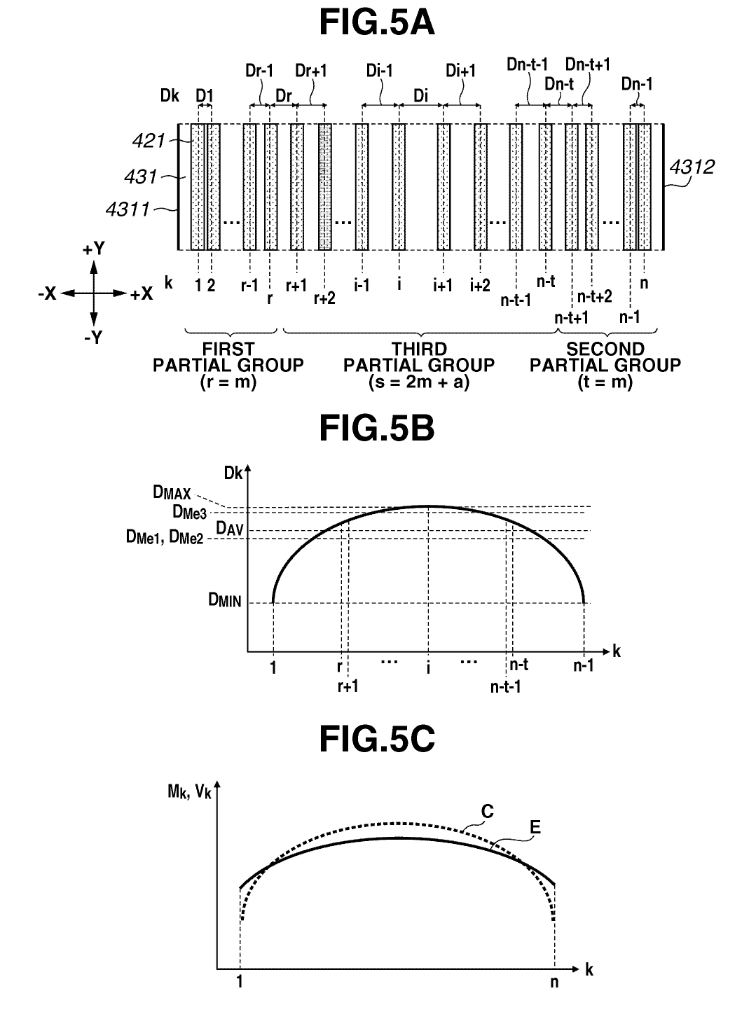

FIG. 5A is an enlarged view illustrating the extension area 451 of the transmission member 411. In the extension area 451, n signal lines are disposed in parallel to each other. The average center-to-center distance D_{Av} in the present exemplary embodiment is similar to that in the wiring configuration illustrated in FIGS. 10A and 10B.

FIG. 5B is a graph illustrating an example distribution of the center-to-center distance Dₖ of the signal lines illustrated in FIG. 5A. The Dₖ distribution is a quadratic function having a convex shape protruding upward. Further, D_{Max} is the center-to-center distance Dᵢ between the i-th signal line and the (i+1)th signal line positioned at the center. Therefore, Dₖ monotonically decreases in narrow sense from k=i to k=1. Further, Dₖ monotonically decreases in narrow sense from k=i+1 to k=n−1. Therefore, the example distribution illustrated in FIG. 5B satisfies all of the conditions (A) to (E).

FIG. 5C includes a solid line E that indicates an example Mₖ distribution obtainable by the wiring configuration illustrated in FIGS. 5A and 5B. FIG. 5C further includes a dotted line C that indicates a comparative Mₖ distribution obtainable by the wiring configuration illustrated in FIGS. 10A and 10B. It is understood from FIG. 5C that the dispersion in Mₖ value may be reduced and, as a result, the dispersion in Vₖ value may be reduced.

As a result, the unevenness in display may be reduced. Similar to the first exemplary embodiment, if the difference between D_{Max} and D_{Min} is extremely increased, the dispersion in Mₖ value may deteriorate compared to that of the dotted line C. Therefore, it is necessary to appropriately set the Dₖ distribution.

### Third Exemplary Embodiment

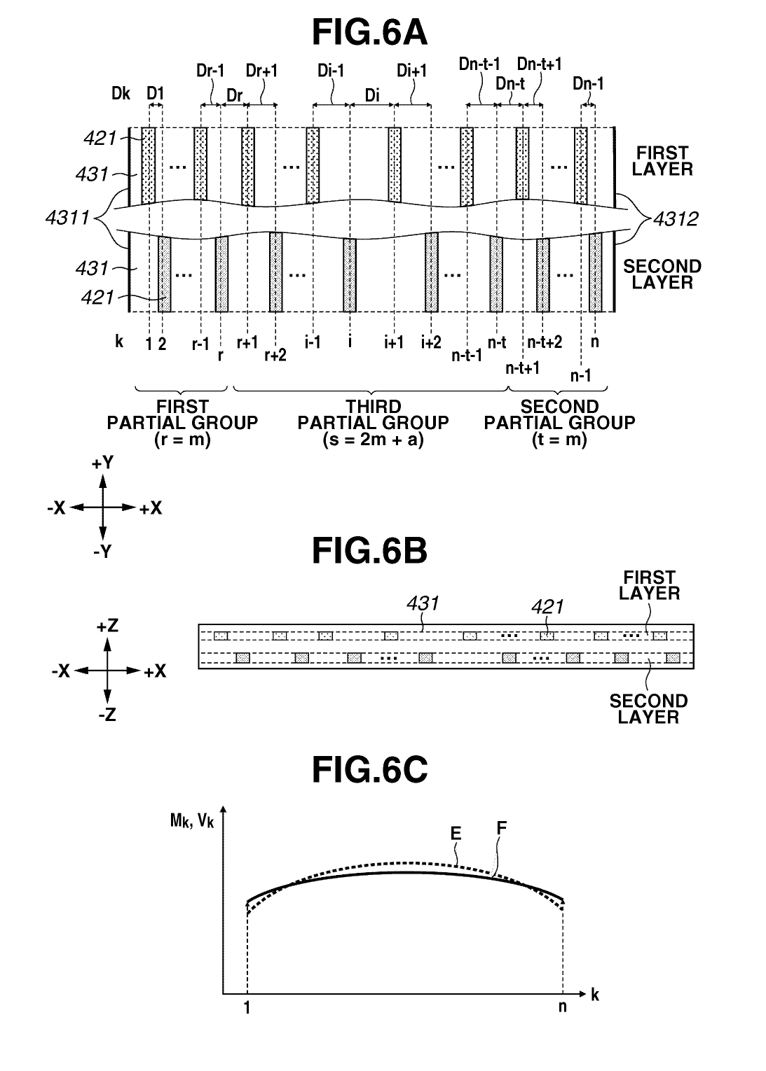

As illustrated in FIGS. 6A and 6B, a signal line group maybe divided into two or more layers (e.g., a first layer and a second layer) in the same transmission member. The transmission member includes an insulating layer intervening between the first layer and the second layer. According to the example illustrated in FIGS. 6A and 6B, if a signal line group is composed of n signal lines as described in the second exemplary embodiment, odd number signal lines are disposed in the first layer and even number signal lines are disposed in the second layer.

The first layer includes n/2 signal lines that are disposed in parallel to each other in a mutually spaced relationship on a two-dimensional plane. Similarly, the second layer includes n/2 signal lines that are disposed in parallel to each other in a mutually spaced relationship on a two-dimensional plane. As described above, when the signal line group is divided into a plurality of layers, it is feasible to reduce the mutual inductance Mₖ and may appropriately set the center-to-center distance between mutually neighboring signal lines.

FIG. 6C includes a solid line F that indicates an example Mₖ distribution obtainable by the wiring configuration illustrated in FIGS. 6A and 6B. FIG. 6C further includes a dotted line E that indicates the comparative Mₖ distribution obtainable according to the second exemplary embodiment. It is understood from FIG. 6C that the dispersion in Mₖ value may be reduced and, as a result, the dispersion in Vₖ value may be reduced.

### Fourth Exemplary Embodiment

If a wiring, which does not transmit any signal and differs from the signal lines in the current flowing direction, is provided on the transmission member 411, it becomes feasible to obtain effects similar to those obtainable when the signal line group is composed of signal lines that are mutually differentiated in the current flowing direction. In the present exemplary embodiment, the “wiring different from the above-described signal lines” is a wiring that is not connected to the external terminals 12 electrically connected to at least the display elements 1.

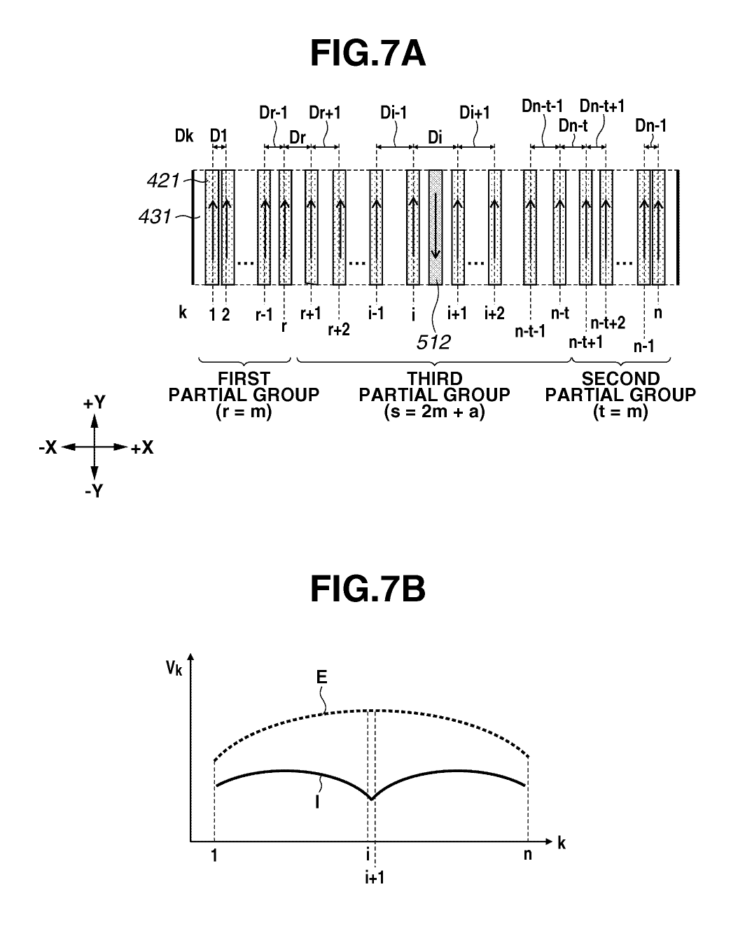

As illustrated in FIG. 7A, it is useful to provide a ground line 512 between two signal lines (e.g., the i-th signal line and the (i+1)th signal line) that constitute a signal line group. The alignment of the signal lines 421 illustrated in FIG. 7A is similar to that of the signal lines described in the second exemplary embodiment. The ground line 512 is a part of the conductive member 502 illustrated in FIG. 3B. Therefore, the direction of the current flowing though the ground line 512 is opposite to the direction of the current flowing though the signal lines 421, as illustrated by arrows in FIG. 7A.

FIG. 7B illustrates a solid line I that indicates a Vₖ distribution obtainable by the wiring configuration illustrated in FIG. 7A. As understood from FIG. 7B, the solid line I is characteristic in that the Vₖ value decreases at the ground line position. FIG. 7B further illustrates a dotted line E that indicates the comparative Mₖ distribution obtainable according to the second exemplary embodiment. It is understood from FIG. 7B that the dispersion in Mₖ value may be reduced and, as a result, the dispersion in Vₖ value may be reduced. As a result, the unevenness in display may be reduced.

Further, the period of the luminance unevenness distribution becomes shorter. It becomes feasible to suppress the display unevenness that may be visually recognized. The ground line 512 may be provided at an arbitrary position between two signal lines of the transmission member 411. However, it is desired that the ground line 512 is disposed between two signal lines that belong to the third partial group. It is further desired that the ground line 512 is disposed between two signal lines disposed at the center of the signal line group. The effect of the ground line 512 may be enhanced when the number of ground lines is increased.

### Fifth Exemplary Embodiment

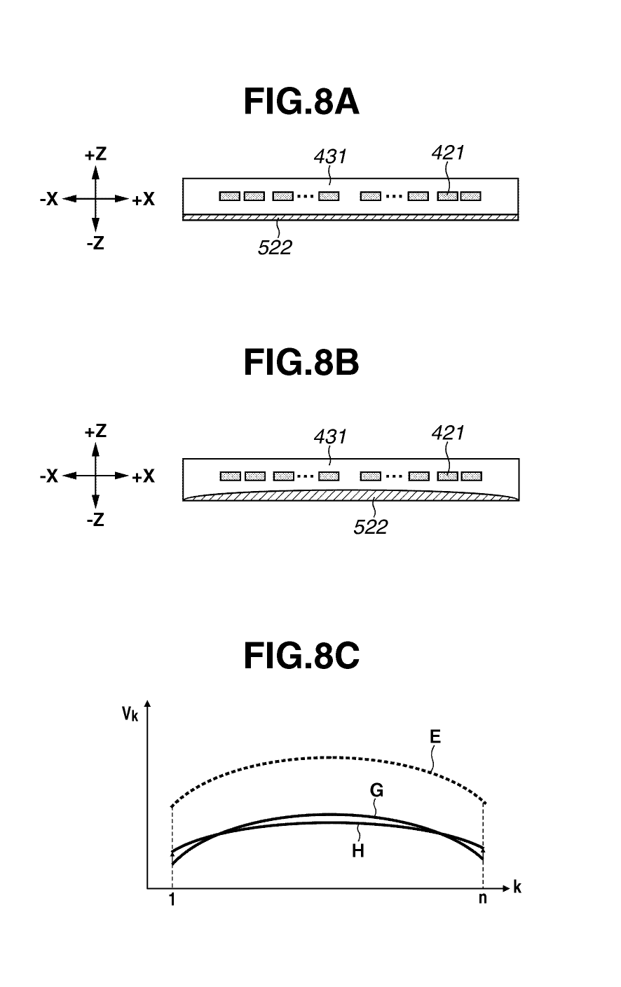

As illustrated in FIGS. 8A and 8B, it is useful to provide a conductive layer 522 in such a way as to face the signal line group on the surface of the insulating substrate 431, or at a position spaced from the surface of the insulating substrate 431. The alignment of the signal lines 421 illustrated in FIGS. 8A and 8B is similar to that of the signal lines described in the second exemplary embodiment. The conductive layer 522 is a part of the conductive member 502 illustrated in FIG. 3B. Therefore, the direction of the current flowing though the conductive layer 522 is opposite to the direction of the current flowing though the signal lines 421.

FIG. 8A illustrates an example characterized in that the distance between each signal line of the signal line group and the conductive layer 522 is constant. FIG. 8B illustrates an example characterized in that the distance between the signal lines of the third partial group and the conductive layer 522 is smaller than the distance between the signal lines of the first (or second) partial group and the conductive layer 522.

FIG. 8C includes a solid line G that indicates a Vₖ distribution obtainable by the wiring configuration illustrated in FIG. 8A and a solid line H that indicates a Vₖ distribution obtainable by the wiring configuration illustrated in FIG. 8B, whose Vₖ values are smaller than those of the dotted line E according to the second exemplary embodiment. Accordingly, it becomes feasible to suppress the display unevenness that may be visually recognized. The wiring configuration illustrated in FIG. 8B is superior to the wiring configuration illustrated in FIG. 8A in that the dispersion in Vₖ value is smaller and, therefore, the unevenness in display may be reduced.

### Sixth Exemplary Embodiment

As illustrated in FIG. 9A, it is useful to provide a dummy line 532 between the left side of the insulating substrate 431 and the first partial group of the transmission member 411 and a dummy line 542 between the right side of the insulating substrate 431 and the second partial group of the transmission member 411. The alignment of the signal lines 421 illustrated in FIG. 9A is similar to that of the signal lines described in the second exemplary embodiment.

The dummy lines 532 and 542 are not connected to the external terminals 12. The dummy line 532 is connected to a load 552, and the dummy line 542 is connected to a load 562. The modulation IC 401 supplies a modulation signal to the dummy line. When the modulation signal is transmitted via the dummy lines 532 and 542 to the loads 552 and 562 respectively, the current flows through the dummy lines 532 and 542 in a direction similar to the flowing direction of the current flowing through the signal lines 421.

FIG. 9B illustrates a solid line J that indicates Mₖ and Vₖ distributions appearing on the signal line group when the current flows through the dummy lines 532 and 542. FIG. 9B further illustrates a dotted line E that indicates the comparative Mₖ distribution obtainable by the wiring configuration illustrated in FIGS. 4A and 4B. When the current flows through the dummy lines 532 and 542, the Vₖ value becomes larger. However, the dispersion in Mₖ and Vₖ values becomes smaller in the signal line group. In this case, it is desired that the loads 552 and 562 are substantially equal to (or within ±10% of) the load of the display panel 10 when seen from the signal lines.

More specifically, it is desired that the load 552 has an impedance component that is substantially equal to (or within ±10% of) a sum of the resistance value of the modulation line 4 connected to the 1st signal line and a capacitance value between the modulation line 4 and a plurality of scanning lines connected to the display elements each connected to the modulation line 4. It is also desired that the load 562 has a similar impedance component.

Further, it is desired that the signal to be input to the dummy lines 532 and 534 is similar to the modulation signal to be input to their neighboring signal lines because the Mₖ value changes continuously and, therefore, the luminance unevenness may be reduced. The signal lines adjacent to the dummy lines are not limited to the signal lines belonging to the same transmission member.

For example, as illustrated in FIGS. 2A and 2B, it is desired to provide the dummy lines on each of two mutually neighboring modulation signal transmission members 411 and 411. In this case, it is desired that the modulation signal to be input to the dummy line provided on the other side of the modulation signal transmission member 411 is similar to the modulation signal to be input to the 1st signal line of the modulation signal transmission member 411. Further, it is desired that the modulation signal to be input to the dummy line provided on one side of the transmission member 411 is similar to the modulation signal to be input to the n-th signal line of the transmission member 411. The above-described arrangement is useful in that the unevenness in display may be reduced not only in each signal line group but also between signal line groups.

The ground line 512, the conductive layer 522, and the dummy lines 532 and 542 described in the fourth to sixth exemplary embodiments may be added, as a single element or a combination thereof, to the example wiring configurations illustrated in the first to third exemplary embodiments in which the center-to-center distance of the signal lines has a distribution. Further, the ground line 512, the conductive layer 522, and the dummy lines 532 and 542 described in the fourth to sixth exemplary embodiments may be added to the comparative wiring configurations illustrated in FIGS. 10A and 10B in which the center-to-center distance of the signal lines is constant. In each case, the dispersion in Vₖ value may be reduced.

A practical example described below is a demonstrative manufacturing of a High Definition TeleVision (HDTV) display having 1920 pixels (in the X direction)×1080 pixels (in the Y direction), in which each pixel is constituted by three RGB sub-pixels aligned in the X direction (i.e., the direction perpendicular to the modulation line).

The demonstrative manufacturing includes providing 1080 scanning lines 3 and 5760 (=1920×3) modulation lines 4 on a rectangular glass substrate having a diagonal length of 1450 mm, in such a manner that the scanning lines 3 and the modulation lines 4 are mutually perpendicular to each other. The demonstrative manufacturing further includes providing 1080 scanning wiring terminals 13 that correspond to respective scanning lines 3 and 5760 modulation wiring terminals 14 that correspond to respective modulation lines 4.

The demonstrative manufacturing further includes forming approximately 6,220,000 surface-conduction electron−emitter elements at respective crossing points of the scanning lines 3 and the modulation lines 4, in such a way as to connect a low potential electrode (e.g., cathode) to the scanning line 3 and connect a high potential electrode (e.g., gate) to the modulation line 4. Through the above-described processes, a rear plate may be manufactured.

The demonstrative manufacturing further includes forming a black matrix having approximately 6,220,000 apertures on a rectangular glass substrate having a diagonal length of 1400 mm. The demonstrative manufacturing further includes forming a fluorescent layer for each aperture in such a manner that RGB fluorescent members are periodically disposed and aligned in a matrix pattern. The demonstrative manufacturing further includes forming a metal back face plate on respective fluorescent layers.

The demonstrative manufacturing further includes positioning the face plate and the rear plate via a spacer, in a vacuum chamber, in such a way as to place each electron emission device and a corresponding fluorescent layer in an opposed relationship. The demonstrative manufacturing further includes sealing the faceplate and the rear plate hermetically via a frame member while maintaining a clearance of 1.5 mm between the face plate and the rear plate. As a result, it is feasible to obtain a display panel (FED panel) including approximately 6,220,000 cathode luminescent elements aligned in a matrix pattern and disposed inside the frame member (internal area).

In the demonstrative manufacturing, each of the scanning signal transmission members 311 and the modulation signal transmission members 411 is made of an FPC. A polyimide substrate having a thickness of 93 μm, a width of 55 mm, and a length of 300 mm may be used as the insulating substrate 331 of the scanning signal transmission member 311. A copper foil having a thickness of 35 μm and a width of 300 μm may be used as each signal line 321 of the scanning signal transmission member 311.

The demonstrative manufacturing includes embedding 90 signal lines at the depth of 38 μm from the front surface and 20 μm from the back surface of the polyimide substrate. The demonstrative manufacturing further includes providing an extension area of the scanning signal transmission member 311, in which 90 signal lines are aligned in parallel to each other in the width direction in such a manner that the center-to-center distance of mutually neighboring signal lines maintains a uniform value of 450 μm. The extension area has a length of 250 mm. Further, the demonstrative manufacturing includes packaging the scanning IC 301 on the polyimide substrate.

A polyimide substrate having a thickness of 66 μm, a width of 40 mm, and a length of 250 mm may be used as the insulating substrate 431 of the modulation signal transmission member 411. A copper foil having a thickness of 8 μm and a width of 80 μm may be used as each signal line 421 of the modulation signal transmission member 411. The demonstrative manufacturing further includes embedding 240 signal lines 421 at the depth of 38 μm from the front surface and 20 μm from the back surface of the polyimide substrate.

The demonstrative manufacturing further includes providing an extension area of the modulation signal transmission member 411, in which 240 signal lines 421 are aligned in parallel to each other in such a manner that the center-to-center distance of mutually neighboring signal lines monotonically decreases toward each side of the polyimide substrate along a quadratic curve in a range from 82 μm to 207 μm. The extension area has a length of 200 mm. Further, the demonstrative manufacturing includes packaging the modulation IC 401 on the polyimide substrate.

According to a simulation conducted to calculate a mutual inductance Mₖ of the 240 signal lines that constitute the modulation signal transmission member, the obtained Mₖ distribution monotonically decreases in narrow sense from the 120th signal line to the 1st signal line and also from the 121st signal line to the 240th signal line as indicated by the dotted line E in FIG. 5C.

A comparative modulation signal transmission member, which was prepared for comparison, includes 240 signal lines aligned in parallel to each other in the width direction, in which the center-to-center distance between mutually neighboring signal lines is maintained at a uniform value of 165 μm.

According to a simulation conducted to calculate a mutual inductance Mₖ of the 240 signal lines of the comparative modulation signal transmission member, the obtained Mₖ distribution monotonically decreases in narrow sense from the 120th signal line to the 1st signal line and also from the 121st signal line to the 240th signal line, as indicated by the distribution C in FIG. 10A. However, the comparative modulation signal transmission member has a greater value with respect to the standard deviation of the mutual inductance Mₖ.

Next, twelve scanning signal transmission members 311, each having 90 signal lines and made of an anisotropic conductive film (ACF), is connected to the scanning wiring terminals 13 of the display panel 10. Further, 24 modulation signal transmission members 411, each having 240 signal lines and made of ACF, are connected to the modulation wiring terminals 14 of the display panel 10.

Further, each of the scanning signal transmission members 311 and each of the modulation signal transmission members 411 are connected to an electric circuit substrate on which the control circuit 60 and the image processing circuit 70 are mounted.

A voltage pulse signal having non−selected potential V_{N} (=+6V), selected potential V_{S} (=−9V), pulse width of 7.7 μs, and frequency of approximately 120 Hz is successively input as the scanning signal, while shifting the timing of voltage pulses, to respective scanning wiring terminals 13. Further, a voltage pulse signal (PWM) having black display potential V_{B} (=V), white display potential V_{W} (=+10V), pulse width (=0 to 6.9 μs), and frequency of approximately 150 kHz is simultaneously input as the modulation signal, to all of the modulation wiring terminals 14 in synchronization with the pulse of the scanning signal.

A voltage of 10 kV is applied to the metal back. Thus, 5760 cathode luminescence devices connected to the same scanning line 3 are simultaneously turned on. Further, the simple matrix drive is line-sequentially performed for every scanning line 3 to realize a progressive display of 120 frames per second. In this case, current of several mA flows through each signal line 421 of the modulation signal transmission member 411.

A demonstrative display was performed by adjusting the modulation signal in such a way as to change the gradation of the screen stepwise from 0% gradation (entire black display) to 25% gradation, 50% gradation, 75% gradation, and 100% gradation (entire white display) when the peak luminance is equal to 480 cd/cm². As a result of observation on the display screen, the unevenness in display was not confirmed in each gradation level.

For comparison, a similar display was performed using the comparative modulation signal transmission member. As a result of observation on the display screen, a stripe display unevenness illustrated in FIG. 11A was confirmed in each display of 25% gradation, 50% gradation, and 75% gradation.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-229818 filed Oct. 12, 2010, which is hereby incorporated by reference herein in its entirety.

What is claimed is:

1. An image display apparatus comprising:
a display panel that includes a plurality of display elements and a plurality of terminals electrically connected to the plurality of display elements, respectively;
an integrated circuit configured to output an electric signal to drive each of the plurality of display elements; and
a plurality of transmission members disposed in a mutually spaced relationship and configured to transmit electric signals from the integrated circuit to the plurality of terminals,
wherein each of the plurality of transmission members includes a signal line group composed of (4m+a) signal lines, which connect the plurality of terminals to the integrated circuit and transmit the electric signal, and an insulating substrate that supports the signal line group,
wherein each of the plurality of transmission members includes an area in which the (4m+a) signal lines that constitute the signal line group are extended in the same direction and aligned in a mutually spaced relationship,
wherein, in the area, the signal line group includes a first partial group composed of m signal lines, a second partial group composed of m signal lines, and a third partial group composed of (2m+a) signal lines and positioned between the first partial group and the second partial group, and
wherein a center-to-center distance between mutually neighboring signal lines of the first partial group and a center-to-center distance between mutually neighboring signal lines of the second partial group are set to be shorter than a center-to-center distance between mutually neighboring signal lines of the third partial group, so that, when the integrated circuit outputs the electric signal to the (4m+a) signal lines that constitute the signal line group to drive the plurality of display elements at a same luminance level, the luminance of the plurality of display elements connected to the signal lines that constitute the first partial group and the second partial group becomes equal to the luminance of the plurality of display elements connected to the signal lines that constitute the third partial group (in which “m” is an arbitrary natural number equal to or greater than 2, and “a” is any one of 0, 1, 2, and 3).

2. An image display apparatus comprising:
a display panel that includes a plurality of display elements and a plurality of terminals electrically connected to the plurality of display elements, respectively;
an integrated circuit configured to output an electric signal to drive each of the plurality of display elements; and
a plurality of transmission members disposed in a mutually spaced relationship and configured to transmit electric signals from the integrated circuit to the plurality of terminals,
wherein each of the plurality of transmission members includes a signal line group composed of (4m+a) signal lines, which connect the plurality of terminals to the integrated circuit and transmit the electric signal, and an insulating substrate that supports the signal line group,
wherein each of the plurality of transmission members includes an area in which the (4m+a) signal lines that constitute the signal line group are extended in the same direction and aligned in a mutually spaced relationship,
wherein, in the area, the signal line group includes a first partial group composed of m signal lines, a second partial group composed of m signal lines, and a third partial group composed of (2m+a) signal lines and positioned between the first partial group and the second partial group,
wherein a medium value of the center-to-center distance between mutually neighboring signal lines of the m signal lines belonging to the first partial group and a medium value of the center-to-center distance between mutually neighboring signal lines of the m signal lines belonging to the second partial group are smaller than a medium value of the center-to-center distance between mutually neighboring signal lines of the (2m+a) signal lines belonging to the third partial group, and
wherein a maximum value of the center-to-center distance between mutually neighboring signal lines of the signal lines that constitute the signal line group is equal to or less than 50 times a minimum value of the center-to-center distance between mutually neighboring signal lines of the signal lines that constitute the signal line group (in which “m” is an arbitrary natural number equal to or greater than 2, and “a” is any one of 0, 1, 2, and 3).

3. The image display apparatus according to claim 1, wherein a maximum value of the center-to-center distance between mutually neighboring signal lines of the signal lines that constitute the signal line group is equal to or greater than two times and equal to or less than 10 times a minimum value of the center-to-center distance between mutually neighboring signal lines of the signal lines that constitute the signal line group.

4. The image display apparatus according to claim 1, wherein a minimum value of the center-to-center distance between mutually neighboring signal lines of the signal lines that constitute the signal line group is equal to or greater than 0.1 times an average value of the center-to-center distance between mutually neighboring signal lines of the signal lines that constitute the signal line group.

5. The image display apparatus according to claim 1, wherein mutually neighboring signal line groups of the plurality of transmission members are spaced by a distance equal to or greater than ¼ times the center-to-center distance between signal lines positioned at both ends of respective mutually neighboring signal line groups.

6. The image display apparatus according to claim 1, wherein a maximum value of the center-to-center distance between each signal line of the first partial group and a neighboring signal line thereof positioned adjacent to the second partial group and a maximum value of the center-to-center distance between each signal line of the second partial group and a neighboring signal line thereof positioned adjacent to the first partial group are smaller than a minimum value of the center-to-center distance between mutually neighboring signal lines of the signal lines that constitute the third partial group.

7. The image display apparatus according to claim 1, wherein the integrated circuit is configured to supply current that simultaneously flows through respective signal lines of the signal line group in the same direction.

8. The image display apparatus according to claim 1, wherein the integrated circuit is configured to supply current that simultaneously flows through respective signal lines of the signal line group in the same direction,
wherein the image display apparatus further comprises at least one of a ground line, a dummy line, and a conductive layer,
wherein the ground line is provided between two signal lines included in the third partial group, in which the ground line is not connected to the terminal and a direction of current flowing through the ground line is opposite to a direction of current flowing through the signal line group,
wherein the dummy line is provided between one side of the signal line group and the first partial group and between another side of the signal line group and the second partial group, wherein the dummy line is not connected to the terminal and simultaneously transmits electric signals to the signal line group, and a direction of current flowing through the dummy line is similar to a direction of current flowing through signal lines of the signal line group, and
wherein the conductive layer is provided in an opposed relationship with the signal line group via the insulating substrate, wherein the conductive layer is not connected to the terminal and a direction of current flowing through the conductive layer is opposite to a direction of current flowing through the signal line group.

9. The image display apparatus according to claim 1, wherein the plurality of display elements are aligned in a matrix pattern and connected to the terminals via a matrix wiring, and the plurality of display elements are multiplex driven by a circuit including a plurality of the integrated circuits.

10. The image display apparatus according to claim 1, wherein the display elements are cathode luminescence devices.
